(19) United States
(12) Patent Application Publication
(10) Pub. No.: US 2014/0361908 A1
(43) Pub. Date: Dec. 11, 2014

(54) WIRELESS UTILITY METERING DEVICES, SYSTEMS, AND METHODS

(71) Applicants: Matt Laird, Boulder, CO (US); Mark Shamley, Boulder, CO (US); Duane Switzer, Erie, CO (US); Brennan Dayberry, Longmont, CO (US)

(72) Inventors: Matt Laird, Boulder, CO (US); Mark Shamley, Boulder, CO (US); Duane Switzer, Erie, CO (US); Brennan Dayberry, Longmont, CO (US)

(21) Appl. No.: 14/298,865

(22) Filed: Jun. 6, 2014

Related U.S. Application Data
(60) Provisional application No. 61/832,148, filed on Jun. 6, 2013.
(60) Provisional application No. 61/832,155, filed on Jun. 7, 2013.

(51) Int. Cl. G01D 4/00; G01F 1/075

(52) U.S. Cl. CPC G01D 4/002; G01F 1/0755
USPC 340/870.02; 73/861.77

(57) ABSTRACT

A multifunction electronic device generally involving a processor, a power source in electronic communication with the processor; and wireless communicator, the wireless communicator in electronic communication with the processor and the power source. The processor controls the wireless communicator in a manner that minimizes power consumption by the multifunction electronic device, whereby the power source is conserved. The multifunction electronic device serves at least one function, such as a register device or a remote device. The multifunction electronic device wirelessly communicates with a remote server, such as a cloud-based server, and performs metering measurements by way of a magnetic field sensor for enhancing accuracy of such measurements.

### CROSS-REFERENCE TO RELATED APPLICATION

This document is a non-provisional patent application claiming priority to, and the benefit of, U.S. Provisional Patent Application Ser. No. 61/832,148; filed Jun. 6, 2013, also entitled “Wireless Utility Metering Devices, Systems, and Methods;” and U.S. Provisional Patent Application Ser. No. 61/832,155; filed Jun. 7, 2013; also entitled “Wireless Utility Metering Devices, Systems, and Methods;” both of which are herein incorporated by reference in their entirety for all purposes.

### TECHNICAL FIELD

The present disclosure relates to “green” or “eco-friendly” (ecologically-friendly) technologies for metering water usage. More specifically, the present disclosure relates to green technologies for metering water usage in the field. Even more specifically, the present disclosure relates to green technologies for wirelessly metering water usage in the field.

### BACKGROUND

Many related art technologies are currently utilized for metering water usage. One of the greatest challenges in the related art is development of a smart meter system, e.g., in the machine-to-machine market, where human interaction has been eliminated from the communications. One problem experienced in the related art smart meters us that the currently available chipsets do not perform sufficiently for low-power, primary-cell battery applications.

Typical related art water meters use a pair of magnets to drive a mechanical odometer. Referring to FIG. 1, this diagram illustrates a perspective view of a register 9 that attaches to conventional water meters, wherein a second magnet 130′ is used to track a first magnet 130 of the meter (not shown), in accordance with the related art. Almost all water meters for at least the past fifty (50) years use a magnetic drive. The measuring element in the water meter is coupled with the magnet 130′ at the top of the meter housing. A corresponding magnet 130 is disposed in the mechanical register. When these two magnets 130, 130′ couple, and the measuring element essentially pulls the upper magnet 130′ as well as the connected register gear train and odometer 12 wheels. This related art technique for tracking water consumption results in introducing drag and other frictional forces on the measuring element, thereby greatly reducing accuracy, especially low flow accuracy. This drag effect worsens with age of the water meter and continuing exposure to the environment. The number of gears and odometer 12 wheels in the register add to the drag and other frictional forces, which means that most manufacturers of such related art devices are limited to the number of wheels, whereby the resolution of the register is greatly reduced, thereby providing information that is less useful.

The prior art also includes first generation smart meters that can wirelessly transmit usage data, use a conventional magnetic sensor or a conventional flow sensor for evaluating the water flow, and use a power line connection or a lithium battery as a power source. The prior art also includes meter registers that use electromagnetic switches such as red switches to determine flow usage.

While these background examples may relate to mechanical water meter and first generation smart meter technologies in general, they fail to disclose a smart meter device or system that minimizes battery failures, prolongs battery life, or conserves battery power, use an advanced magnetic field sensor, and incorporates a remotely addressable shut-off valve and irrigation management systems using wireless transceivers for communication between providers and users. As such, a long-felt need has been experienced in the related art for a large-scale smart meter device, system, and methods that overcome the inherent vulnerability of batteries as well as providing improved accuracy in meter readings and meter control.

### SUMMARY

In addressing many of the problems experienced in the related art, such as battery failures and inaccurate meter readings, the present disclosure generally involves a multi-function electronic device, such as a register device, adapted for wireless communication with a remote server, a remote device adapted for wireless communication with a remote server, a system comprising a multifunction electronic device, as well as corresponding methods of fabrication and use for such devices and system. The present disclosure undertakes describing various embodiments believed to overcome the power consumption obstacle faced in the related art and to achieve a battery lifetime acceptable to performance in the utility market. In addition to minimizing power consumption, the multifunction electronic device, serving as a register device, utilizes a sensor, rather than a magnet, to track the meter, whereby more accurate readings are provided. Further, the electronic device further provides other features, such as a flow-rate display, data-logging, and output options.

Further, the multi-function electronic device, serving as a register device, generally comprises a magnetic field sensor and a microcontroller (FIG. 2), in accordance with the present disclosure. The magnetic field sensor does not introduce any drag on the meter magnet, thereby facilitating increasing efficiency of a measuring element. Also, the magnetic field sensor transmits signals that correspond to actual turns of the meter magnet to the microcontroller, thereby increasing the resolution for data-logging and data functions. The multi-function electronic device includes, but is not limited to, the following benefits: increasing resolution of data by recording every meter magnet turn, restoring and improving low-flow accuracy by improving measurement performance, providing universal compatibility with most common residential or commercial water meters, and enhancing revenues by improving data accuracy,

Alternatively, a multi-function electronic device is adapted to serve, not only as a register device, but also as a remote device, for interfacing with a fluid metering body, such as a conventional water meter. The multi-function electronic device, when used as a register device, is disposable in relation to the fluid metering body, e.g., via attachment or placement at a location proximal the fluid metering body, the fluid metering body having a magnet that spins when experiencing a fluid flow, the register device serving as both a register (index) and a wireless communications device. The multi-function electronic device, when used as a remote device, is disposable in relation to a fluid metering body register via hard wires, querying data from the fluid metering body register and serving as the communications device. The multi-function electronic device has an LCD as the primary user interface and is used primarily by public or private water utilities for use in metering, meter reading, customer service, and providing advanced data analytics. In addition, the multi-function electronic device utilizes a low power microcontroller for controlling all circuitry and functions. The microcontroller executes operations that are based on algorithms for minimizing “on-time” in order to conserve battery life.

In general, the multi-function electronic device, when used as a register device, monitors the rotation of a magnet on the measuring element of a fluid metering body by way of a magnetic sensor. The register device comprises a digitization circuit, utilizing a high-resolution state chart algorithm, for facilitating tracking a forward flow and a reverse flow, an anti-aliasing filter with an advanced algorithm for detecting a fluid metering body register removal or a magnetic tampering. Algorithms are used for basic consumption counting, flow rate conversion, and measurement testing.

Unlike many related art devices, rather than using a coupling magnet, the multi-function electronic device, when used as a register device, utilizes a field magnetic sensor to detect the motion of the magnet in the meter, in accordance with the present disclosure. The electronic device has a microcontroller which employs a state machine algorithm to track each 1/16^{th} of a magnet's turn. The algorithm also determines the direction of the turn clockwise (CW) or counter-clockwise (CCW). The sensor does not exert any drag on the meter's measuring element. As such, the multi-function electronic device, when used with a water meter, provides better low-flow accuracy than does a typical water meter's original (OEM) mechanical register. The sensor also transmits very high-resolution consumption information, e.g., approximately less than 1/100^{th} of a gallon, to the microcontroller for applying its data algorithms and logging.

In general, the multi-function electronic device, when used as a remote device, the multi-function electronic device can be coupled to a multitude of fluid metering body registers through common wired interfaces. The remote device is queried for the consumption data. Tamper detection circuitry provides indication of a cut cable or malfunctioning fluid metering body register. In particular, the multi-function electronic device has also implemented two circuits or functions for handling potential tampering of the fluid metering body. With a related art magnetic sensor, an unscrupulous end-consumer of water, e.g., an unscrupulous homeowner or an unscrupulous business-owner, could possibly use a very strong magnet to impede the related art sensor's operations. To combat this conduct, the multi-function electronic device offers an additional layer of security to the utility provider by implementing a dynamic register and tamper-detection system in combination with a specialized magnetic field sensor. The signals from the magnetic sensor of the present disclosure are transmitted through an analog-to-digital converter (ADC) and analyzed with routines in the microcontroller. From the analysis, the multi-function electronic device determines whether the meter register has been removed from the fluid metering body or if a tampering magnetic field is present.

Due to the inherent logistics of the water utility industry, such as the absence of available power mains in many locations (off-grid), the multi-function electronic device would be powered via a long-life battery. The requirement for the wireless cellular communications and utility outputs necessitates a sophisticated power electronics scheme to power different parts of the circuitry at different voltages at different times. A salvage circuit is provided to allow re-energizing of the microcontroller and the LCD via an external power source to obtain a final reading if the battery fails. Due to the installation sites, costs, and safety concerns, related art water meters are not powered, i.e., only mechanical measuring elements and mechanical registers are used. To add electronic capabilities, the only option is to run the register on battery power. Most ultra-low power electronics run on a default voltage of approximately 3.0 VDC or approximately 3.6 VDC. However, within a typical register, there are multiple functions and outputs which require voltages other than the default voltage. For instance, a wireless module, e.g., a cellular module, requires approximately 4.1 VDC to operate reliably. The electronic device of the present disclosure implements power circuitry to power both the wireless module and the lower voltage circuitry under all operating conditions. The architecture of the present disclosure includes current sensing and battery voltage detection which is used for on-board diagnostics and battery life projection.

As a register device, the multi-function electronic device utilizes high resolution data from the sensor to log consumption in non-volatile memory (EEPROM). This data can be stored in increments as low as one minute. As a remote device, the multi-function electronic device utilizes the data returned or counted from the connected fluid metering body register to log consumption in the memory. The resolution of the data is dependent upon the fluid metering body register. The register device has an infrared port for local communications. This port can be used for reading, configuration, diagnostics, and boot-loading. With respect to data-logging, consumption data for individual accounts is useable for many purposes, including leak detection, conservation monitoring, and customer service interface. In the water utility industry, the water meter register only provides the current read (index) of the meter and is queried by an advanced meter reader (AMR) device or an advanced metering infrastructure (AMI) device which then stores or transmits the data. With the multi-function electronic device of the present disclosure, high-resolution data is storable on board, e.g., by way of the EEPROM, wherein the stored data is useable for on-board algorithms, such as leak detection, high-usage monitoring, conservation monitoring, back-flow detection, and zero usage monitoring, and the like. This stored data is accessible at any time for immediate use, e.g., for a customer service review, and also serves as data backup for the AMI system. In the multi-function electronic device, an AMR device is optionally embedded.

A method of using the multi-function electronic device is also encompassed by the present disclosure which addresses the battery power requirement by controlling communications, wherein the wireless communication module is switched off until its use is required. At a pre-determined time range, the wireless communication module is powered-on wherein the wireless communication module negotiates network access and then broadcasts a standard packet to the remote server. Following the broadcast, the wireless communication module waits for an acknowledgement from the remote server or an additional command for functions such as re-configuration, addition data or boot-loading. Following all communications, the wireless communication module is powered-off. This method, comprising waking-and-broadcasting and normally powering-off the wireless communication module allows the multi-function electronic device to reach operational life expectations of water utilities.

The multi-function electronic device accommodates new firmware loaded (boot-loaded) through either the infrared port or the wireless cellular module. Through the infrared port, the boot-loader interfaces to a handheld or tablet computer. Through the wireless communication module, the boot-loader interfaces to the remote service. Firmware corrections or new algorithms can be loaded via this boot-loader.

The multi-function electronic device also uses configurable algorithms for consumption analysis. The high resolution data-logging allows the invention to track common consumption patterns such as leaks, zero-usage, high usage and backflow. When one of these patterns is detected, a flag is set in memory and then sent within the wireless daily broadcast. In this method, the invention pre-processes the data for the utility. The flags sent allow automatic reporting and notifications.

An electronic device for facilitating utility metering generally comprises a processor, a power source, such as a battery, in electronic communication with the processor; and wireless communicator, the wireless communicator in electronic communication with the processor and the power source, the processor controlling the wireless communicator in a manner that minimizes power consumption by the electronic device, whereby a longevity of the power source is increased, and the electronic device being adapted to serve at least one function, such as a register device and a remote device, in accordance with the present disclosure. The wireless communicator comprises a cellular feature for communicating utility usage data to a server, such as a remote server, a cloud-based server, a remote cloud-based server. The electronic device further comprises circuitry for facilitating operation thereof, wherein the wirelessly communicating means is adapted to transmit data only in binary packets for minimizing usage of bandwidth, and wherein the wirelessly communicating means is adapted to transmit data only during off-peak hours for minimizing power consumption.

A wireless system for facilitating utility metering generally comprises an electronic device in communication with a server, the electronic device generally comprising a processor, a power source, such as a battery, in electronic communication with the processor; and wireless communicator, the wireless communicator in electronic communication with the processor and the power source, the processor controlling the wireless communicator in a manner that minimizes power consumption by the electronic device, whereby a longevity of the power source is increased, and the electronic device being adapted to serve at least one function, such as a register device and a remote device, in accordance with the present disclosure. The wireless communicator comprises a cellular feature for communicating utility usage data to a server, such as a remote server, a cloud-based server, a remote cloud-based server. The electronic device further comprises circuitry for facilitating operation thereof, wherein the wirelessly communicating means is adapted to transmit data only in binary packets for minimizing usage of bandwidth, and wherein the wirelessly communicating means is adapted to transmit data only during off-peak hours for minimizing power consumption.

A method of handling utility usage data comprises collecting utility usage data by at least one magnetic-field sensor and transmitting the utility usage data to at least one server by a wireless communicator, wherein the transmitting step is performed only in binary packets for minimizing usage of bandwidth, and wherein the transmitting step is performed only during off-peak hours for minimizing power consumption, in accordance with the present disclosure

The multi-function electronic device has a wireless communication module that is used for data reporting to a remote server. The wireless communication module allows for deployment in a variety of existing wireless networks. The existing cellular network provides a network for all communications back to a remote server. The multi-function electronic device, therefore, does not require additional network equipment or infrastructure for communication. The multi-function electronic device, comprising a wireless module, e.g., a cellular module, is also embeddable within water meter register and has several advantages. The use of an existing cellular network by the multi-function electronic device provides significant business advantages. Since most AMI manufacturers utilize proprietary RF techniques, these AMI manufacturers have full control of the physical layer and the protocol. The proprietary network typically requires the deployment of infrastructure, e.g., towers, aggregators/multiplexors, collectors, repeaters, etc., which is cost-prohibitive (both in deployment and in maintenance) and results in logistical difficulties for most utilities, since these infrastructure devices require vertical assets, e.g., building, poles, towers, etc., for optimal mounting locals. The utilization of an existing cellular network by the multi-function electronic device provides significant advantages, particularly the elimination of new infrastructure. The multi-function electronic device comprises a unique integration of a wireless module (M2M-type) into a battery-powered register device. Power management, including the full power-off of the module for all, but approximately 20 seconds of, the day is a significant achievement, especially in the water industry. The data handling of the transmission packet from a binary packet to an encoded data collection system, e.g., a cloud service, is also a difficult function. The multi-function electronic device is adapted to receive 2-way messages/commands from a top-end system.

### BRIEF DESCRIPTION OF THE DRAWING

The above, and other, aspects, features, and advantages of several embodiments of the present disclosure will be more apparent from the following Detailed Description as presented in conjunction with the following several figures of the Drawing.

FIG. 1 is a diagram illustrating a typical odometer register, in accordance with the related art.

FIG. 2 is a diagram illustrating a multi-function electronic device, serving as a register device, comprising a magnetic field sensor and a microcontroller, the register device adapted to wirelessly communicate with a remote server, such as in a wireless utilities metering system, in accordance with an embodiment of the present disclosure.

FIG. 3 is a schematic diagram illustrating a multi-function electronic device, serving as a register device, adapted to wirelessly communicate with a remote server, such as in a wireless utilities metering system, in accordance with an embodiment of the present disclosure.

FIG. 4 is a schematic diagram illustrating a multi-function electronic device, serving as a remote device, adapted to wirelessly communicate with a remote server, such as in a wireless utilities metering system, in accordance with an embodiment of the present disclosure.

FIG. 5 is a table illustrating at least one counting algorithm, involving signal digitization and sampling, of signals transmitted by an anisotropic magneto-resistive sensor to a signal digitization circuit, in accordance with an embodiment of the present disclosure.

FIG. 6 is schematic diagram illustrating the relative positions of a magnet, such as found in a fluid meter body, in relation to the algorithms as shown in FIG. 5, in accordance with the present disclosure.

FIG. 7 is a table illustrating a relationship between a sampling frequency and a movement of a magnet, such as found in a fluid meter body, in accordance with an embodiment of the present disclosure.

FIG. 8 is a diagram illustrating a top view of a multi-function electronic device, serving as a register device, adapted to wirelessly communicate with a remote server, such as in a wireless utilities metering system, in accordance with an embodiment of the present disclosure.

FIG. 9 is a diagram illustrating a top view of a multi-function electronic device, having a user interface, an indicia feature, and an IR port, in accordance with an embodiment of the present disclosure.

FIG. 10 is a diagram illustrating a top perspective view of a multi-function electronic device, as shown in FIG. 6, serving as a register device, in accordance with an embodiment of the present disclosure.

FIG. 11 is a diagram illustrating a top perspective exploded view of a multi-function electronic device, as shown in FIG. 6, serving as a register device, in accordance with an embodiment of the present disclosure.

FIG. 12 is a diagram illustrating a top perspective internal view of a multi-function electronic device, serving as a remote device, adapted to wirelessly communicate with a remote server, such as in a wireless utilities metering system, in accordance with an embodiment of the present disclosure.

FIG. 13 is a diagram illustrating an exploded view of a multi-function electronic device, serving as a remote device, in accordance with an embodiment of the present disclosure.

FIG. 14 is a diagram illustrating a top perspective view of a multi-function electronic device, as shown in FIG. 12, serving as a remote device, in accordance with an embodiment of the present disclosure.

FIG. 15, is a diagram illustrating a top perspective view of a multi-function electronic device, as shown in FIG. 11, serving as a register device, in accordance with an embodiment of the present disclosure.

FIG. 16 is a diagram illustrating a top perspective view of a multi-function electronic device, serving as a register device, in accordance with an embodiment of the present disclosure.

FIG. 17 is a diagram illustrating a top perspective view and a detailed top view of a multi-function electronic device, serving as a register device, in accordance with an embodiment of the present disclosure.

FIG. 18 is a diagram illustrating a bottom perspective view and a detailed bottom view of a multi-function electronic device, serving as a register device, in accordance with an embodiment of the present disclosure.

FIG. 19 is a diagram illustrating a detailed top view of a printed circuit board assembly, comprising the circuitry of a multi-function electronic device, serving as a register device, in accordance with an embodiment of the present disclosure.

FIG. 20 is a diagram illustrating a detailed bottom view of the a printed circuit board assembly, comprising the circuitry of a multi-function electronic device, serving as a register device, in accordance with an embodiment of the present disclosure.

FIG. 21 is a diagram illustrating an exploded view of a multi-function electronic device, serving as a register device, in accordance with an embodiment of the present disclosure.

FIG. 22 is a diagram illustrating a top perspective view of a multi-function electronic device, serving as a remote device, in accordance with an embodiment of the present disclosure.

FIG. 23 is a diagram illustrating an exploded view of a multi-function electronic device, serving as a remote device, in accordance with an embodiment of the present disclosure.

FIG. 24 is a flow diagram illustrating a wireless system for facilitating utility metering, in accordance with the present disclosure.

FIG. 25 is a diagram illustrating frontal perspective views of a wireless system for facilitating utility metering, comprising two different endpoints, the two endpoints comprising an electronic register, such as the register device, and a stand-alone modem, in accordance with an embodiment of the present disclosure.

FIG. 26 is a flow diagram illustrating a wireless system for facilitating utility metering, in accordance with the present disclosure.

FIG. 27 is a flow diagram illustrating a wireless system for facilitating utility metering, comprising two different endpoints, the two endpoints comprising an electronic register, such as the register device, and a stand-alone modem, in accordance with an embodiment of the present disclosure.

FIG. 28 is a screenshot illustrating an account table in a window configured to maintain and present record information on each utility account, generated by a wireless utilities metering system, in accordance with an embodiment of the present disclosure.

FIG. 29 is a screenshot illustrating an account table in a window configured to maintain and present record information for the end user, generated by a wireless utilities metering system, in accordance with an embodiment of the present disclosure.

FIG. 30 is diagram illustrating the principles of anisotropic magneto-resistive sensor operation as performed by the sensor utilizing an anisotropic magneto-resistance technique, in accordance with an embodiment of the present disclosure.

FIG. 31 is a diagram illustrating a sensor, comprising four resistive elements oriented in a polygon configuration, being coupled together, end to end, thereby forming a Wheatstone bridge, in accordance with an embodiment of the present disclosure.

FIG. 32 is a graph illustrating a two-cycle waveform plot, in accordance with an embodiment of the present disclosure.

FIG. 33 is a diagram illustrating a sensor, comprising a single Wheatstone bridge in a stationary position, in accordance with an embodiment of the present disclosure.

FIG. 34 is a graph illustrating a transfer curve related to the operation of the sensor, as shown in FIG. 48, in accordance with an embodiment of the present disclosure.

FIG. 35 is a circuit diagram illustrating an instrumentation amplifier circuit, using an op-amp with external discrete components, as incorporated in the sensor, in accordance with an embodiment of the present disclosure.

FIG. 36 is a circuit diagram illustrating a trimming potentiometer circuit for offset trimming, in accordance with an embodiment of the present disclosure.

FIG. 37 is a diagram illustrating a sensor, comprising two Wheatstone bridges, for facilitating measurement of a magnet rotation, in accordance with an embodiment of the present disclosure.

FIG. 38 is a graph illustrating sine and cosine waveforms produced by output of the sensor, comprising two single Wheatstone bridges, as shown in FIG. 34, in accordance with an embodiment of the present disclosure.

FIG. 39 is a circuit diagram illustrating a general circuit for a pair of Wheatstone bridges, as shown in FIG. 34, in accordance with an embodiment of the present disclosure.

FIG. 40 is a diagram illustrating a Hall-Effect sensor for use with a sensor, comprising a pair of Wheatstone bridges, as shown in FIG. 34, for providing full rotational position sensing, in accordance with an embodiment of the present disclosure.

FIG. 41, is a diagram illustrating a sensor used in combination with a Hall-Effect sensor for sensing a full magnet rotation, in accordance with an embodiment of the present disclosure.

FIG. 42 is a graph illustrates resulting waveforms for 360° position sensing, as shown in FIG. 41 in accordance with an embodiment of the present disclosure.

Corresponding reference characters indicate corresponding components throughout the several figures of the Drawing. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood, elements that are useful or necessary in commercially feasible embodiment are often not depicted in order to facilitate a less obstructed view of these various embodiments of the present disclosure.

### DETAILED DESCRIPTION

The following description is not to be taken in a limiting sense, but is made merely for the purpose of describing the general principles of exemplary embodiments. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

Further, the described features, structures, or characteristics of the present disclosure may be combined in any suitable manner in one or more embodiments. In the Detailed Description, numerous specific details are provided for a thorough understanding of embodiments of the disclosure. One skilled in the relevant art will recognize, however, that the embodiments of the present disclosure can be practiced without one or more of the specific details, or with other methods, components, materials, and so forth. In other instances, well-known structures, materials, or operations are not shown or described in detail to avoid obscuring aspects of the present disclosure.

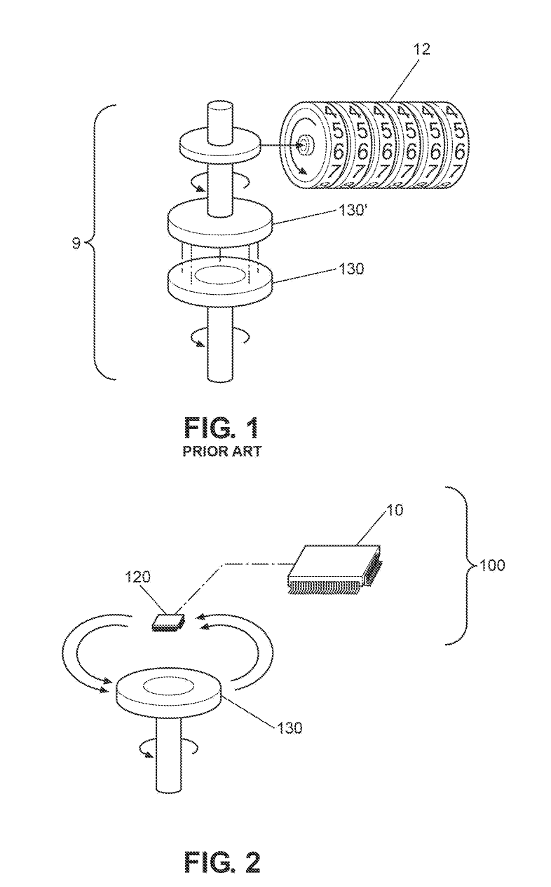

Referring to FIG. 2, this diagram illustrates a multi-function electronic device, serving as a register device 100, comprising a magnetic field sensor 120 and a microcontroller 10, the register device 100 adapted to wirelessly communicate with a remote server 300, such as in a wireless utilities metering system 500, in accordance with an embodiment of the present disclosure. The sensor 120 is spaced apart from a magnet 130, such as a meter magnet, and measures the rotation of the magnet 130. The sensor 120 comprises at least one magneto-resistive element and eliminates the need for related art coupling magnets and related art mechanical odometers.

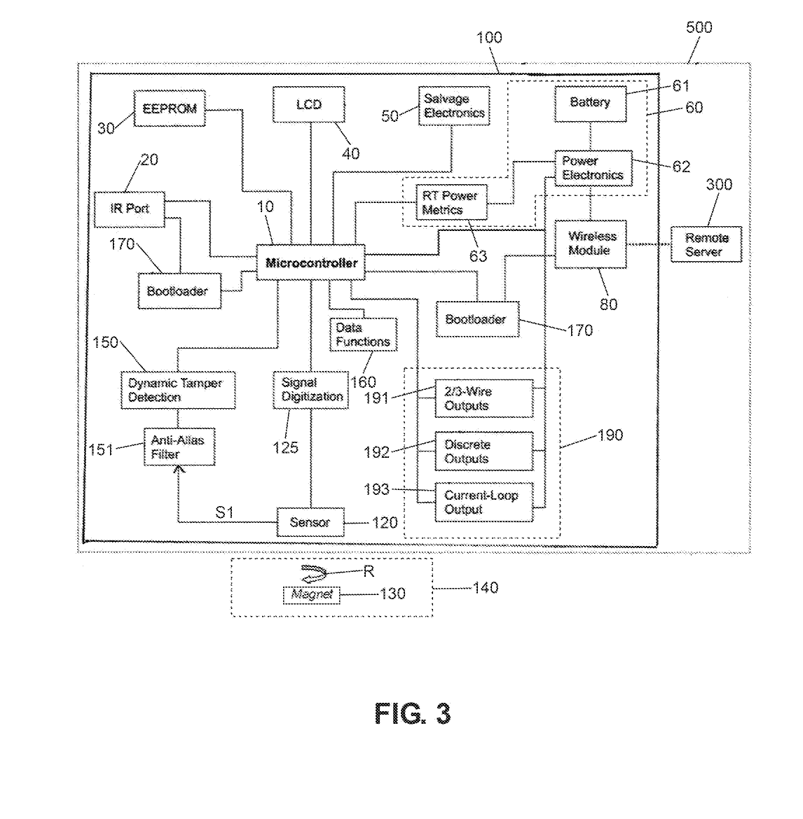

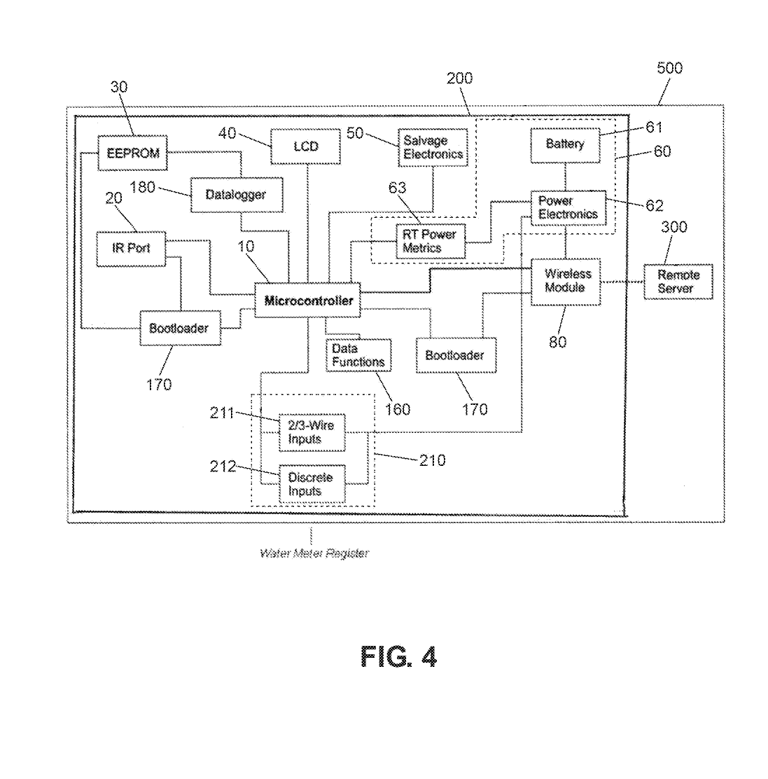

Referring to FIGS. 3 and 4, these schematic diagrams respectively illustrate a multi-function electronic device, serving as a register device 100, comprising a wireless communication module, in accordance with a first embodiment of the present disclosure, and a multi-function electronic device, serving as a remote device 200, comprising a wireless communication module, in accordance with a second embodiment of the present disclosure. Both the register device 100 and the remote device 200 respectively comprise at least one element, such as a microcontroller 10, e.g., a processor or a microprocessor, and infrared (IR) port 20, an electrically erasable programmable read-only memory (EEPROM) 30, a user interface 40 comprising a liquid crystal display (LCD), at least one salvage electronic 50, a power system 60 having at least on feature, such as a power supply 61, power electronics 62, and power measuring and reporting circuitry 63.

Still referring to FIGS. 3 and 4, the microcontroller 10 comprises a multi-function microprocessor with on-board random-access memory (RAM), a flash memory, and general purpose inputs/outputs (GPIO). The microcontroller 10 is adapted to handle low-power applications. The IR port 20 comprises a short-range, directional transceiver adapted to handle local communications, such as would be applicable in relation to the register device 100 or the remote device 200. The IR port 20, comprising the short-range, directional transceiver, uses a communication technique adapted for use with the power system 60 of the present disclosure.

Still referring to FIGS. 3 and 4, the EEPROM 30 comprises a non-volatile, on-board memory, and is used by the microcontroller 10 for storing all data logs. For the register device 100 (FIG. 1), consumption data is stored as a unit corresponding to a number of magnet turns (revolutions). This data is convertible to typical consumption units, such fluid volume units, e.g., gallons, cubic feet, or cubic meters, upon download. For the remote device 200 (FIG. 4), consumption data is stored in the predetermined units therein configured. The EEPROM 30 is also used during a boot-loading process for temporarily storing packets of a new code being downloaded from the IR port 20 or via a wireless module 80.

Still referring to FIGS. 3 and 4, the user interface 40, comprising the LCD, is the primary user interface output. During normal operation, the LCD displays the current-read (index) of the register device 100, e.g., a register, as well as configured volume measurement units, e.g., gallons, cubic feet, or cubic meters. The resolution of the data display by the LCD is configurable. The LCD comprises a flow direction indicator, e.g., forward or reverse, when configured in flow direction mode as well as a flow rate indicator, e.g., in units of GPM or m³/hr, when configured in a flow rate mode. The LCD further comprises a measurement test indicator for a measurement test mode. During wireless cellular communication, the LCD also facilitates display of communication status via the respective user interfaces 40 of the register device 100 and the remote device 200.

Still referring to FIGS. 3 and 4, the at least one salvage electronic 50 comprises a feature, such as a current register-read index adapted for billing an end-water-consumer for consumption during a specific period of time. Since the respective register and remote devices 100, 200 are generally battery-powered, a loss of battery power would result in a failure or compromise in performance by the respective register and remote devices 100, 200, e.g., a failure in displaying the index or in communicating any other information. To prevent or ameliorate this condition, the at least one salvage electronic 50 further comprises an inductive circuit adapted to facilitate inducing a voltage by an external device, whereby a capacitive power circuit of the power system 60 is charged or recharged. Once charged or recharged, the capacitive power circuit allows a specific algorithm to instruct the LCD to momentarily display a final or most recent register-read index.

Still referring to FIGS. 3 and 4, the power system 60 comprises the power supply 61, such as a battery. In the utility industry, a minimum battery life of ten (10) years is expected. However, the related art has not provided any readily available technique for recharging. As such, a long-life (extended operational life), primary cell, such as battery comprising a lithium thionyl chloride in its chemistry, or any other long-life battery know in the arts, whereby high passivation and low self-discharge is provided. The power system 60 operates under two modes of power consumption. The first mode of power consumption occurs during a relatively low power consumption of the register and remote functions, e.g., the register device 100 and the remote device 200, respectively. The second mode of power consumption occurs during a relatively high power consumption of a wireless module 80 during its operation. The register device 100 and the remote device 200 are respectively powerable by a charging source, such as a high energy-density battery, a lower energy-density battery being supplemented with a super capacitor, an electric double layer capacitor (EDLC), a power cord, or any other battery or power source known in the arts.

Still referring to FIGS. 3 and 4, the power system 60 comprises power electronics 62 adapted to handle a variety of electronic conditions. For instance, the register device 100 and the remote device 200 respectively comprise components that require different voltages in order to power different circuitries at different times. By example only, one such component, the microcontroller 10, must be operated nominally at approximately 3.3 VDC. Also, the wireless module 80 must be operated nominally at approximately 4.1 VDC. The utility outputs require approximately 5 VDC for proper operations. The power electronics 62 comprise circuitry and algorithms adapted to, as well as interactively adaptive with, all electronic scenarios.

Still referring to FIGS. 3 and 4, the power system 60 comprises power measuring and reporting circuitry 63 utilizing real-time power metrics. Due to the criticality of battery life, the register device 100 and the remote device 200 each comprise circuitry and algorithms that measure and report an instantaneous voltage and an instantaneous current draw during all primary functions. This information is used by both the register device 100 and the remote device 200 as well as by a remote server 300, utilizing remote server software, to provide information related to real-time battery life as well as long-term battery life.

Referring to FIG. 3, a multi-function electronic device, serving as the register device 100, is adapted to wirelessly communicate with a remote server 300, in accordance with an embodiment of the present disclosure. The register device 100 further comprises a plurality of sensors 120, such as a plurality of anisotropic magneto-resistive sensors, e.g., two anisotropic magneto-resistive sensors 120 for performing a register-counting function, in accordance with the first embodiment of the present disclosure. By example only, the two anisotropic magneto-resistive sensors 120 detect a movement, e.g., in a direction R, of a magnet 130 that is spinning in a fluid meter body 140, such as a water meter body. The two anisotropic magneto-resistive sensors, in particular, facilitate sensing of bi-directional flow for the register device 100. Further, the two anisotropic magneto-resistive sensors, in concert, perform the register-counting function in saturation and with an offset in relation to the magnet 130 that is spinning in the fluid meter body 140. The two anisotropic magneto-resistive sensors 120 are adapted to detect a movement of a magnet 130, such as a four-pole magnet and two-pole magnet.

Still referring to FIG. 3, the multi-function electronic device, serving as the register device 100, further comprises a dynamic tamper-detection feature 150 and an anti-alias filter 151, wherein the dynamic tamper-detection feature 150 comprises an analog-to-digital converter (ADC), such as a sixteen-bit sigma-delta analog-to-digital converter, for processing signals, and wherein the anti-alias filter 151 comprises a single-pole anti-aliasing filter for capturing and filtering signals. For example, signals S₁, being transmitted from the anisotropic magneto-resistive sensors 120, are captured and filtered by the anti-alias filter 150 and subsequently processed by the dynamic tamper-detection feature 150. The amplitudes of the signals S₁, among other possible data, are measured and used to determine whether the magnet 130 in the fluid meter body 140 is sufficiently proximal to the register device 100. Information, such as the amplitudes of the signals S₁ and other possible data, is transmitted to the microcontroller 10, wherein an algorithm is applied to set a register-removal indicator in a communications packet. When the register device 100 is disposed in proximal relation to the fluid meter body 140 and fluid flow occurs, the microcontroller 10 samples the signals S₁ and performs a multi-point transform, such as a five-hundred twelve- (512-) point Fast Fourier Transform (FFT), on the recorded data. The resulting spectral information is then subject to an adaptive algorithm, applied by the microcontroller 10, which evaluates a signature of the data and which determines whether a tampering magnetic field is present. This information is then processed by the microcontroller 10 using another algorithm for setting a tampering indicator within the communications packet.

Still referring to FIG. 3, the multi-function electronic device, serving as a register device 100, further comprises at least one output adapted to interface with at least one third-party AMR device (not shown) and/or at least one third-party AMI device (not shown). In a preferred embodiment, the register device AMR devices and/or at least one third-party AMI devices. For example, the at least one output 190 comprises at least one element, such as a two-wire output or a three-wire output 191, a discrete output 192, and a current-loop output 193. The two-wire output and the three-wire output 191 comprise a serial output which provides a pseudo-standard interface to third-party AMR/AMI devices. such as radios and touchpads. The discrete output 192 provides an interface that is compatible with some older AMR devices which require discrete signals, such as switch closures and active pulses (generators). The current-loop output 193 provides an interface that is compatible with the requirements of many commercial utility accounts, e.g., a current-loop (commonly referred to as a “4-20 mA loop”) which provides instantaneous flow rate information to customer or utility systems. This function requires the flow rate algorithm and the output circuitry to operate. This function provides an analog output proportional to the approximate flow rate of the fluid meter body 140.

Referring again to FIGS. 3 and 4, the register device 100 and the remote device 200 each comprise a data functions module 160, wherein the data functions module 160 applies configurable algorithms to track and flag common fluid consumption patterns, e.g., for water consumption, which may be of interest to the utility. Parameters examined include, but are not limited to, leak detection, high usage, backflow, and zero usage. The data functions module 160 is adapted to detect a leak by confirming whether fluid consumption is consistent in every data log interval over a set period. Inconsistent consumption, e.g., a peak in consumption, indicates a possible leak aft of the fluid meter body 140 and is flagged for notification. If detected, a flag is set and included in a daily broadcast.

Still referring to FIGS. 3 and 4, the data functions module 160 is further adapted to detect a high usage and is configurable with a high-flow threshold or a high-usage threshold as well as with a number of events. If the high-flow threshold or a high-usage threshold is exceeded, e.g., more than the number of events in a period, the detection whereof may indicate excessive irrigation or other high-usage events that may be of interest to the utility. If the high-flow threshold or a high-usage threshold is detected, a flag is set and is included in the daily broadcast.

Still referring to FIGS. 3 and 4, the data functions module 160 is further adapted to detect backflow by monitoring the data logs for a non-positive, i.e., a negative, consumption. If a negative consumption is detected, a reverse flow is indicated, wherein such reverse flow has likely occurred through the fluid meter body 140 and a backflow flag is set and included in a daily broadcast. In addition, the data functions module 160 is further adapted to detect zero usage by monitoring the data logs for zero consumption. If continual zero usage data logs are detected for a pre-set number of days, multiple issues may be indicated, such as water theft, a broken meter, or a vacant account. If continual zero usage detected, a flag is set and included in a daily broadcast. Further, the data functions module 160 is adapted to accept new data functions, implementable in the future, wherein the new data functions are loadable by way of the boot-loader module 170 using a boot-loader function.

Still referring to FIGS. 3 and 4, the register device 100 and the remote device 200 respectively comprise a wireless module 80, such as a cellular module, that provides the primary data communications channel for a utilities metering system 500, wherein the utilities metering system 500 comprises a remote server 300 and either the register device 100 or the remote device 200. The wireless module 80 comprises at least one semiconductor device, such as a chipset or an integrated circuit, that uses at least one wireless technology, such as code-division multiple access (CDMA) or global system for mobile communications or “Groupe Spécial Mobile” (GSM), wherein the at least one wireless technology is standards-based, e.g., based on the Institute of Electrical and Electronics Engineers (IEEE) standards or the European Telecommunications Standards Institute (ETSI) standards. The at least one wireless technology is compatible with consumer electronics, in accordance with the present disclosure.

Still referring to FIGS. 3 and 4, the advanced metering infrastructure (AMI) is the network infrastructure that allows data communications for utility meters and is the network backbone for the smart grid, which runs applications such as demand response, time-of-use billing, outage response, etc. Different platforms provide AMI service, but wireless systems are the predominant ones. Most utility providers utilize some sort of proprietary wireless network to communicate with the endpoint meters. Standard, commercially available networks such as cellphone networks, are sometimes used to communicate from a collector (or aggregator) device. However, in the water industry, a cellular solution for water endpoints was been hitherto unavailable. The overall challenge for a cellular-based product is, once again, stymied by the requirement of being battery powered. The multi-function electronic device, serving as a register device having an embedded CDMA wireless module, is compatible with Verizon network access.

Still referring to FIGS. 3 and 4, a node on the network negotiates an Internet Protocol (IP) address and then remains on the network in most IP network operations. Many CDMA and GSM chipsets have a low-power mode to conserve energy. However, even these operational modes draw a power level that compromises a ten year life expectancy of a battery. As such, the wireless module 80 of the present disclosure is in communication with the remote server 300 and utilizes two techniques for the battery conservation. The first battery conservation technique comprises switching-off the wireless module 80 of either the register device 100 or the remote device 200 at any time when the respective device 100, 200 is not in use. The second battery conservation technique comprises operating in a wake and broadcast mode, rather than staying on the network. The system 500 operates via the register device 100 or the remote device 200 for the vast majority of the time. The system 500 experiences communication over a wireless cellular network by way of the wireless module 80 and the remote server 300 at least once per day at a pseudo-random time. At the broadcast time, the power system 60 powers the wireless module 80, whereby the wireless module 80 negotiates for network access and then sends a daily broadcast via a data packet to the remote server 300.

Still referring to FIGS. 3 and 4, following the broadcast, the remote server 300 either sends a final acknowledgement, indicating that the register device 100 or the remote device 200 can terminate the communications, or sends an additional command. This mode of communications provides full two-way communications. The data packet, having the daily broadcast, comprises identifying information related to a given fluid meter body 140, information related to the consumption flags, diagnostic information, and the high resolution data logs. By utilizing the wireless module 80, the register device 100 or the remote device 200 connects directly and automatically to an existing wireless cellular network, eliminating any need for any aggregation, repeating, or collecting devices. The wireless module 80 further comprises at least one antenna, such as an integral antenna and a remote antenna, for accommodating a variety of locations for typical fluid meter installations.

Still referring to FIGS. 3 and 4, as discussed, the register device 100 or the remote device 200 is in wireless communication with the remote server 300. Since the register device 100 and the remote device 200 utilize an IP network, such as an existing wireless cellular network, the register device 100 and the remote device 200 are both capable of accessing virtually any type of remote server. This architecture provides flexibility for adapting to a plurality of utility customer's requirements and to address emerging technologies, such as cloud-based servers.

Still referring to FIGS. 3 and 4, the register device 100 and the remote device 200 respectively comprise at least one boot-loader 170. The boot-loader 170 comprises software, for driving a dynamic update of firmware as well as a self-update of the boot-loader code. For the register device 100, the boot-loader's 170 software function is accessible via either the IR port 20 or through the wireless module 80. For the remote device 200, the boot-loader's 170 software function is accessible via the wireless module 80. Further, the boot-loader 170 validates a transferred code prior to its implementation for preventing data corruption.

Referring to FIG. 4, this diagram illustrates the multi-function electronic device, serving as a remote device 200, comprising a wireless communication module, in accordance with a second embodiment of the present disclosure. The remote device 200 is adapted to wirelessly communicate with a remote server 300. The remote device 200 further comprises a data-logger 180 for logging data for transmission to the EEPROM 30. All measured consumption data is then stored in the EEPROM 30 for transmission during a daily broadcast and for providing access thereto by the data functions module 160. The data-logger 180 comprises an embedded device that is adapted to simultaneously provide true leak analysis and peak flow analysis. The data logger 180 is further adapted to log data in a time interval of approximately 1 minute and to record fluid consumption with an accuracy of approximately 0.02 gallon. Further, the data-logger 180 is adapted to retrieve up to approximately 32,000 historical data points, e.g., by way of IR or 2-way RF channels for storage into an onboard log memory, corresponding to approximately 111 days at 5-min intervals.

Still referring to FIG. 4, the data-logger 180, for example, performs onboard data-logging with the following data resolutions: at ⅝ minute intervals, the data resolution may be in a range of approximately less than 0.02 gallons; at ¾ minute intervals, the data resolution may be in a range of approximately less than 0.03 gallons; at 1 minute intervals, the data resolution may be in a range of approximately less than 0.2 gallons; at 1.5 minute intervals, the data resolution may be in a range of approximately less than 0.4 gallons; at 2 minute intervals, the data resolution may be in a range of approximately less than 0.4 gallons; at 3 minute intervals, the data resolution may be in a range of approximately less than 0.5 gallons; at 4 minute intervals, the data resolution may be in a range of approximately less than 1.0 gallons; at 6 minute intervals, the data resolution may be in a range of approximately less than 2.0 gallons; at 6 minute intervals, the data resolution may be in a range of approximately less than 6.0 gallons; and at 8 minute intervals, the data resolution may be in a range of approximately less than 6.0 gallons. The default data-logging interval is approximately 5 minutes; however, the multi-function device is programmable to set the interval in a range from approximately 1 minute to approximately 1 hour.

Still referring to FIG. 4, the multi-function electronic device, serving as a remote device 200, further comprises at least one input 210, wherein the at least one input is adapted to interface with at least one third-party AMR/AMI device (not shown). For example, the at least one input 210 comprises at least one element, such as a two-wire input or a three-wire input 211, and a discrete output 212. The two-wire input and the three-wire input 211 comprise a serial input which provides a pseudo-standard interface to third-party AMR/AMI devices, such as encoded-type water meter registers. The discrete input 212 provides an interface that is compatible with some older AMR devices, comprising switch closures and using active pulses, which output discrete signals, such as switch closures and active pulses (generators). In a preferred embodiment, further comprises a plurality of inputs, wherein the plurality of inputs is adapted to interface with a plurality of third-party AMR/AMI devices.

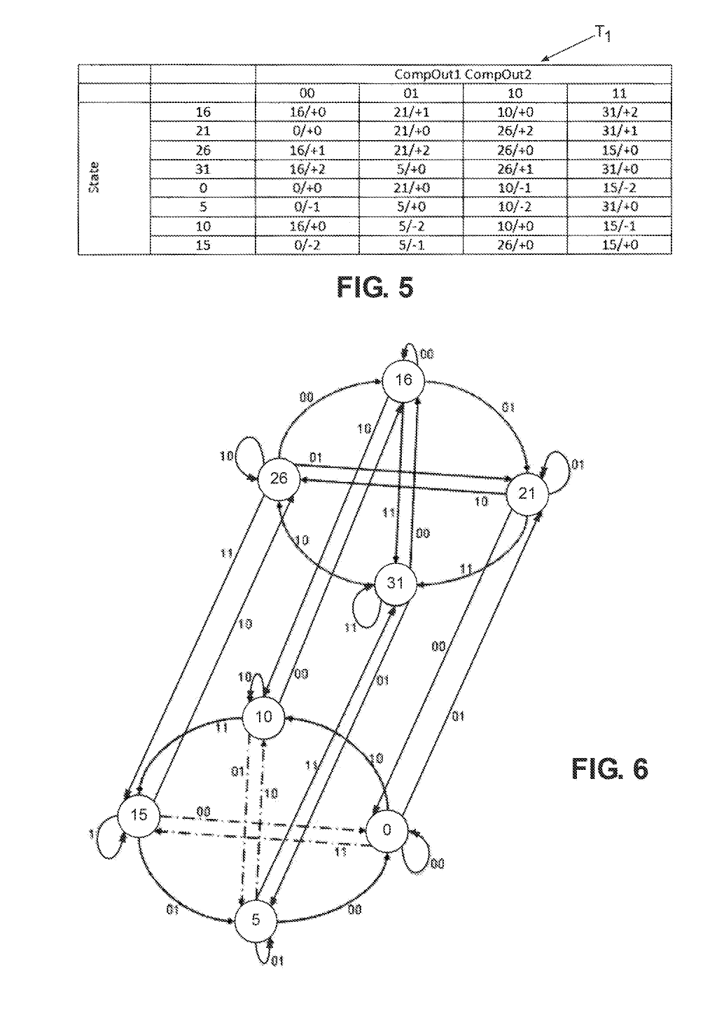

Referring to FIG. 5, this table T₁ illustrates at least one counting algorithm, involving signal digitization and sampling, of signals S₁ being transmitted by the at least one sensor 120, e.g., the at least one anisotropic magneto-resistive sensor, as an analog device to a signal digitization circuit 125, in accordance with an embodiment of the present disclosure. For the counting algorithm, the signals S₁, being transmitted by the at least one sensor 120, require digitization via the signal digitization circuit 125 comprising at least one comparator (not shown). The converted binary levels of a magnetic positioning provide the proper inputs for the counting algorithm. The counting algorithm uses an eight-state technique for tracking a position and a direction of the magnet 130.

Referring to FIG. 6, this schematic diagram illustrates the relative positions of the magnet 130, in accordance with the present disclosure. The second digit indicates a calculation to be performed by the microcontroller 10, e.g., having a processor or microprocessor, on a half-turn (half-revolution) value (+0, +1, +2, −1, −2) (See also FIG. 3.). A value of a “half-turn” or a “half-revolution” that is equal to “16” corresponds to a count of one (1) turn in a positive direction.

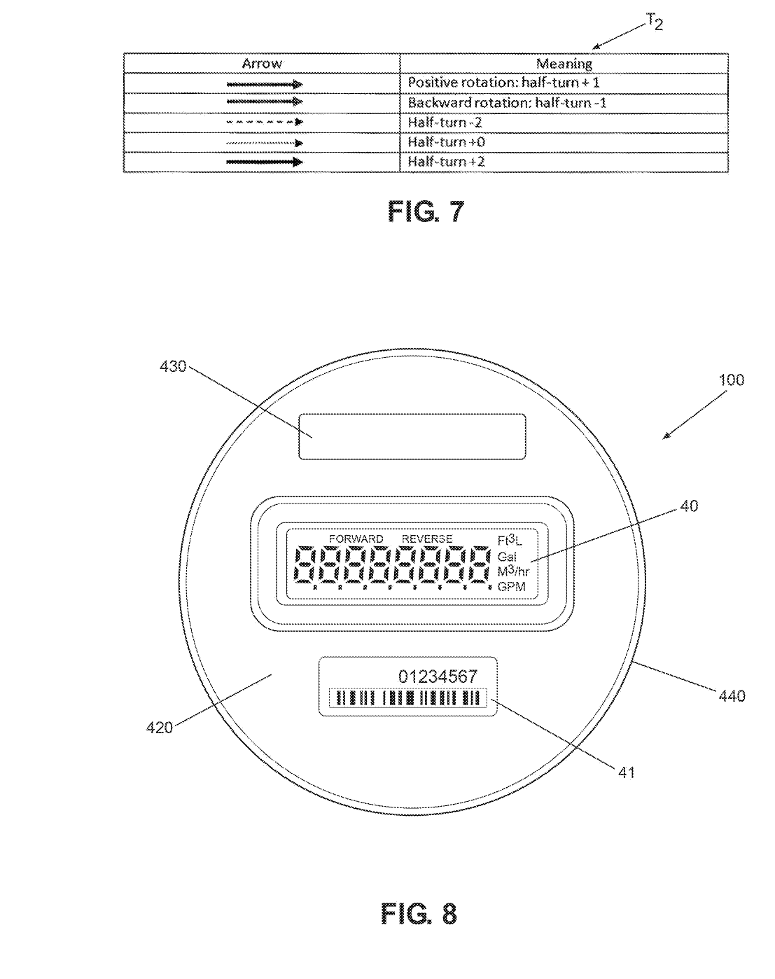

Referring to FIG. 7, this table T₂ illustrates a relationship between the sampling frequency and the movement of the magnet 130, in accordance with an embodiment of the present disclosure. The sampling frequency of the signal digitization circuit 125 is nominally approximately 200 Hz, but the sampling frequency is accelerated to approximately 800 Hz upon detection of a flow, e.g., by way of sensing a turn by the magnet 130. In so doing, both detection of the occurrence of all flow and implementation of a power-saving mode in the absence of flow are achieved, in accordance with the present disclosure. The counting algorithm for the register device 100 is set as the highest priority within the code operation.

Referring to FIG. 8, this top view diagram illustrates a multi-function electronic device, serving as a register device 100, adapted to wirelessly communicate with a remote server 300, such as in a wireless utilities metering system 500, in accordance with an embodiment of the present disclosure. The register device 100 further comprises a lid 420 having an opening for accommodating an antenna 430 and for facilitating visual access to the user interface 40, such as an LCD, wherein the LCD comprises a high-resolution LCD which displays at least eight (8) digits for indicating consumption data. The LCD is further adapted to toggle between displaying total consumption data and flow rate data.

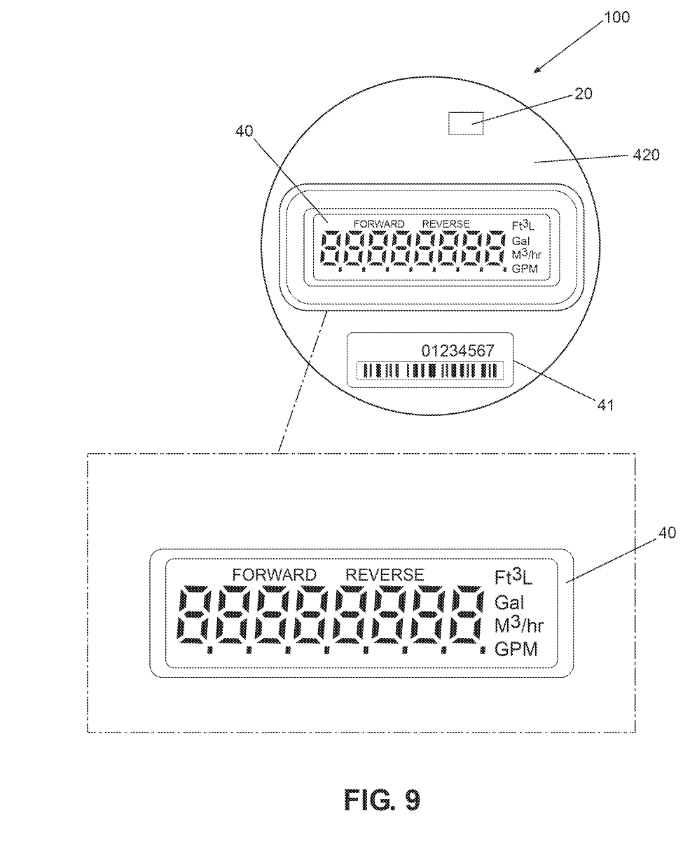

Referring to FIG. 9, this top view diagram illustrates a multi-function electronic device, serving as a register device 100, adapted to wirelessly communicate with a remote server 300, such as in a wireless utilities metering system 500, in accordance with an embodiment of the present disclosure. The register device 100 further comprises an IR port 20 and a lid 420 having an opening for accommodating an antenna 430 and for facilitating visual access to the user interface 40, such as an LCD, wherein the LCD comprises a high-resolution LCD which displays at least eight (8) digits for indicating consumption data. The LCD is further adapted to toggle between displaying total consumption data and flow rate data. The user interface 40 is adapted to display “forward” and “reverse” flow data, total flow volume, flow rate, and many other parameters, such as user-configurable programmable measuring units. The device 100 also has an indicia feature 41 for accommodating a serial number and a bar code.

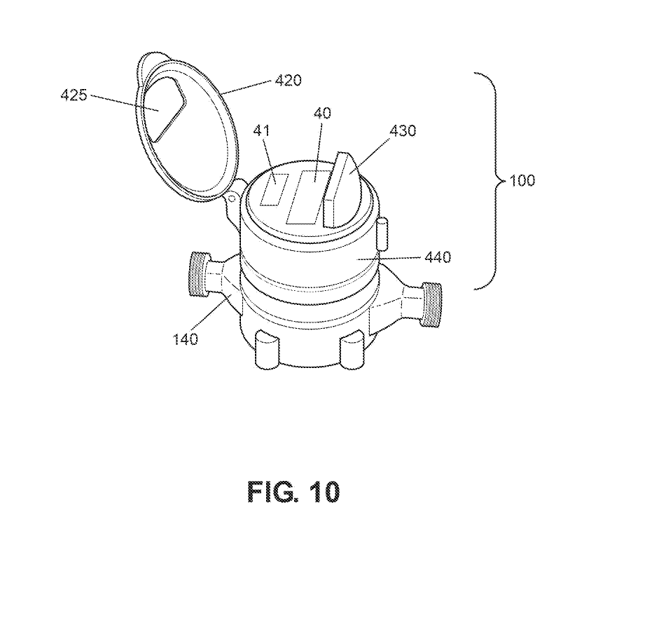

Referring to FIG. 10, this top perspective view diagram illustrates a multi-function electronic device, as shown in FIG. 6, serving as a register device 100, adapted to wirelessly communicate with a remote server 300, such as in a wireless utilities metering system 500, in accordance with an embodiment of the present disclosure. The register device 100 is shown as being mounted to a fluid metering body 140, by example only, and further comprises a lid 420 having an opening 425 for accommodating an antenna 430, such as an integral antenna, for facilitating visual access to the user interface, such as an LCD, and for providing access to the internal components of the register device 100. The register device 100 comprises a housing 440. The lid 420 is mechanically coupled with the housing 440 in a manner such as being rotatably coupled. The device 100 is further submersible and operable in an environmental temperature range of approximately −4° F. to approximately 176° F. or in an environmental temperature range of approximately −20° C. to approximately 80° C. The device 100 comprises a width in a range of approximately 3.12 in and a height of approximately 2.98 in.

Still referring to FIG. 10, the device 100 comprises an enclosure portion, a sealing portion, a potting portion, and a housing portion. The enclosure portion comprises a material, such as a polycarbonate and a UV-protected polycarbonate. The sealing portion comprises a material, such as an adhesive and a UV-curable adhesive. The potting portion comprises a material, such as a dielectric gel and a self-healing dielectric gel. The housing comprises a material, such as a polymeric material, a plastic, a thermoplastic, a hardened thermoplastic, a hardened thermoplastic having an ultraviolet (UV) protection characteristic, a PC-ABS material, a composite material, or any other durable material suitable to the purpose.

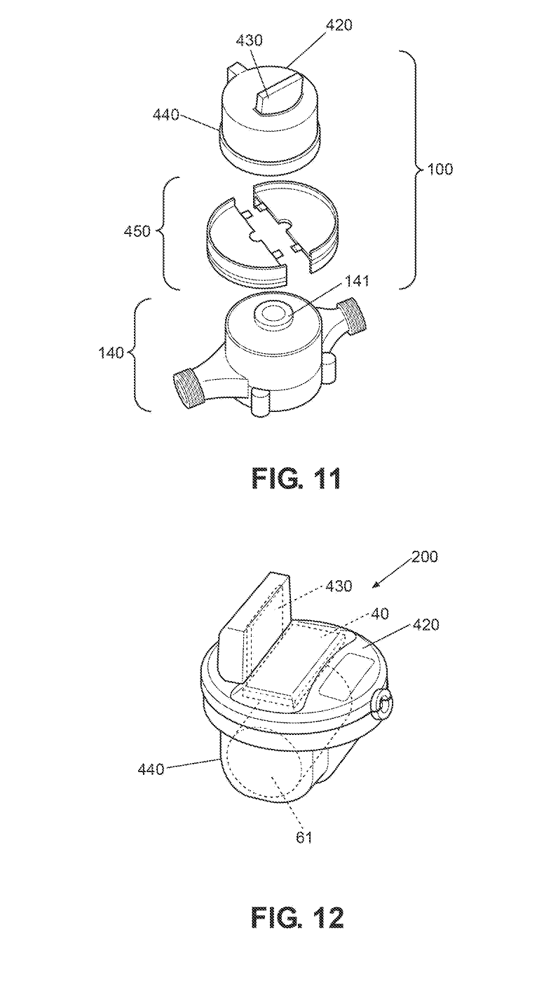

Referring to FIG. 11, this diagram illustrates a top perspective exploded view of a multi-function electronic device, as shown in FIG. 10, serving as a register device 100, adapted to wirelessly communicate with a remote server 300, such as in a wireless utilities metering system 500, in accordance with an embodiment of the present disclosure. The register device 100 is mountable to a fluid metering body, by example only. The register device 100 comprises a housing 440. The register device 100 further comprises a mounting member 450 having a plurality of portions, wherein the plurality of mounting member portions accommodate a bottom portion of the housing 440 as well as rotational indicator 131 of a fluid metering body 140 for facilitating proximal disposition of a field magnetic sensor of the device 100 to a magnet 130 of the fluid metering body 140.

Referring to FIG. 12, this diagram illustrates a top perspective internal view of a multi-function electronic device, serving as a remote device 200, adapted to wirelessly communicate with a remote server 300, such as in a wireless utilities metering system 500, in accordance with an embodiment of the present disclosure. The remote device 200 comprises a housing 440 that accommodates a power source, such as a battery 460, a user interface, such as an LCD 470, and an antenna 430. The device 200 comprises a width of approximately 3.12 in and a height of approximately 2.08 in.

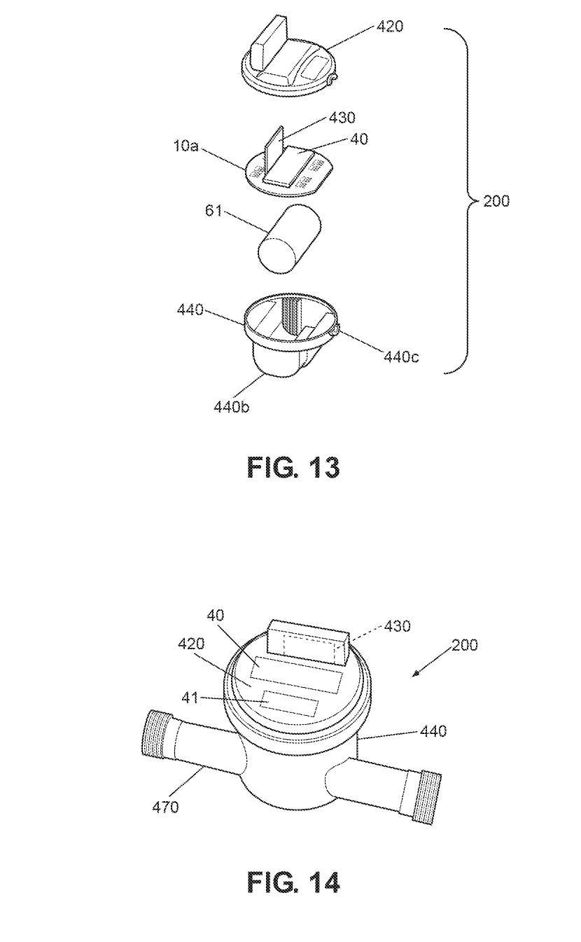

Referring to FIG. 13, this diagram illustrates an exploded view of a multi-function electronic device, serving as a remote device 200, adapted to wirelessly communicate with a remote server 300, such as in a wireless utilities metering system 500, in accordance with an embodiment of the present disclosure. The remote device 200 comprises a housing 440 having a top portion 440a or a lid 420 and a bottom portion 440b, the bottom portion accommodates a power source, such as a battery. The top portion accommodates an antenna and an LCD. The bottom portion comprises an orifice 440c for facilitating electrical communication received by an electrical cable (not shown) from a register (not shown) of a fluid metering body 140.

Referring to FIG. 14, this diagram illustrates a top perspective view of a multi-function electronic device, as shown in FIG. 10, serving as a remote device 200, adapted to wirelessly communicate with a remote server 300, such as in a wireless utilities metering system 500, in accordance with an embodiment of the present disclosure. The device 200 further comprises a conduit member 470 for facilitating mechanical communication by a register of a fluid metering body with the remote device 200. The conduit 470 accommodates an electrical cable (not shown) from a register (not shown) of a fluid metering body 140.

Referring to FIG. 15, this diagram illustrates a top perspective view of a multi-function electronic device, as shown in FIG. 10, serving as a register device 100, adapted to wirelessly communicate with a remote server 300, such as in a wireless utilities metering system 500, in accordance with an embodiment of the present disclosure. The register device 100 is shown as being mounted to a fluid metering body 140, by example only, and further comprises a lid 420 having at least one opening 425 for accommodating an antenna 430, such as an integral antenna, for facilitating visual access to the user interface 40, such as an LCD, for facilitating visual access to a device serial number or other indicia 41, such as a bar code, and for providing access to the internal components of the register device 100. The register device 100 comprises a housing 440.

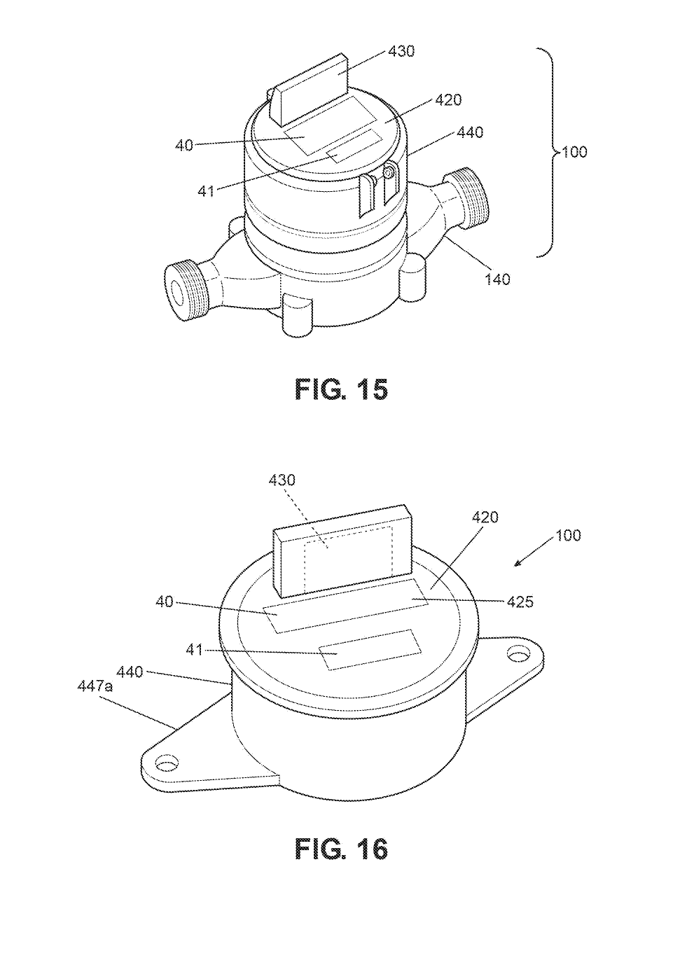

Referring to FIG. 16, this diagram illustrates a top perspective view of a multi-function electronic device, serving as a register device 100, adapted to wirelessly communicate with a remote server 300, such as in a wireless utilities metering system 500, in accordance with an embodiment of the present disclosure. The register device 100 is mountable to a fluid metering body 140, by example only, and further comprises a lid 420 having at least one opening 425 for accommodating an antenna 430, such as an integral antenna, for facilitating visual access to the user interface 40, such as an LCD, for facilitating visual access to a device serial number or other indicia 41, and for providing access to the internal components of the register device 100. The register device 100 comprises a housing 440. The lid 420, in this embodiment, comprises a visually transparent or translucent material. The housing 440 comprises at least one flange 447a for facilitating disposition of the device 200 in relation to the fluid metering body 140. The flange 447a has at least one orifice 447b for accommodating at least one fastener (not shown) for mechanically coupling the device 100 with the fluid metering body 140.

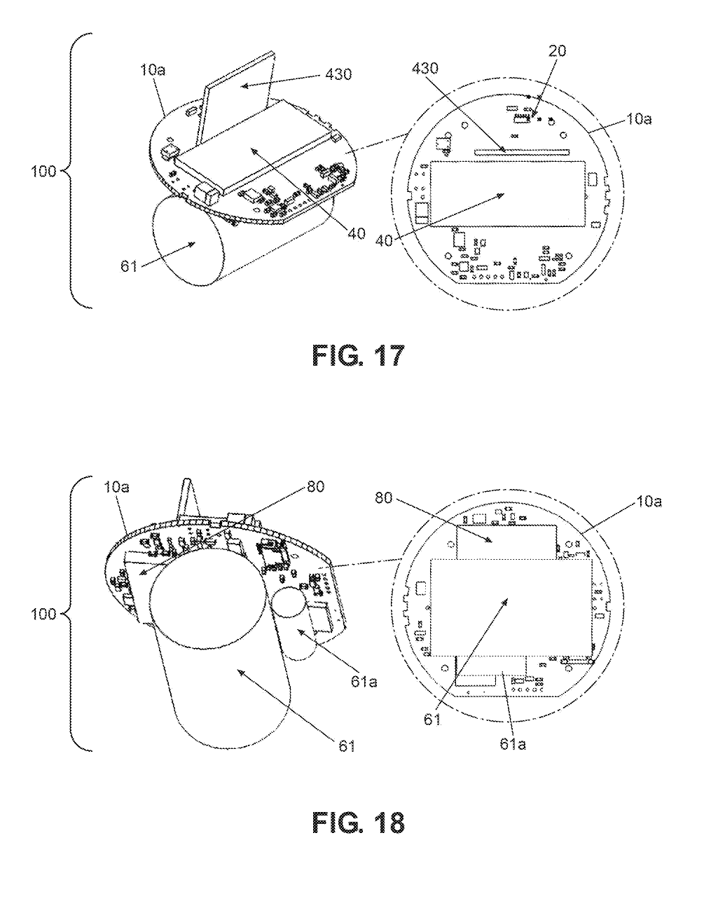

Referring to FIG. 17, this diagram illustrates a top perspective view and a detailed top view of a multi-function electronic device, serving as a register device 100, adapted to wirelessly communicate with a remote server 300, such as in a wireless utilities metering system 500, in accordance with an embodiment of the present disclosure. The device 100 comprises an integral antenna 430 and an IR port 20 in this embodiment. The device 10 further comprises a printed circuit assembly (PCA) 10a for accommodating the at least one circuit of the device 100. The battery 61 is disposed below the PCA 10a. The user interface 40 and the integral antenna 430 are disposed above the PCA 10a.

Referring to FIG. 18, this diagram illustrates a bottom perspective view and a detailed bottom view of a multi-function electronic device, serving as a register device 100, adapted to wirelessly communicate with a remote server 300, such as in a wireless utilities metering system 500, in accordance with an embodiment of the present disclosure. The device 100 comprises a wireless module 80 and a super-capacitor 61a for boosting the battery 61 in this embodiment. The device 10 further comprises a printed circuit assembly (PCA) 10a for accommodating the at least one circuit of the device 100. The battery 61 is disposed below the PCA 10a. The user interface 40 and the integral antenna 430 are disposed above the PCA 10a. The wireless module 80 and the super-capacitor 61a are disposed below the PCA 10a

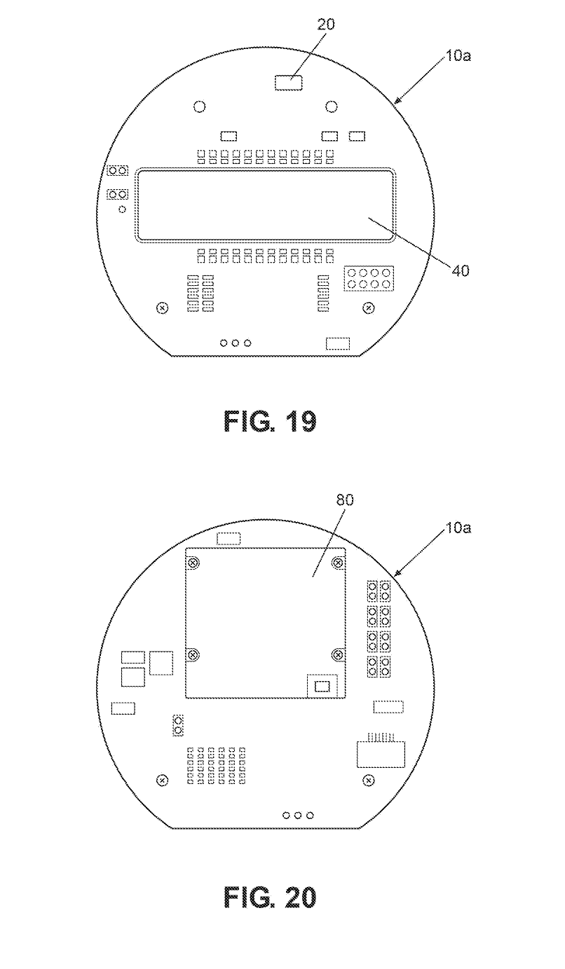

Referring to FIG. 19, this diagram illustrates a detailed top view of the circuitry of a multi-function electronic device, serving as a register device 100, adapted to wirelessly communicate with a remote server 300, such as in a wireless utilities metering system 500, in accordance with an embodiment of the present disclosure. The device 100 comprises an integral antenna 430 and an IR port 480 in this embodiment.

Referring to FIG. 20, this diagram illustrates a detailed bottom view of the circuitry of a multi-function electronic device, serving as a register device 100, adapted to wirelessly communicate with a remote server 300, such as in a wireless utilities metering system 500, in accordance with an embodiment of the present disclosure. The device 100 comprises a wireless module 80 and a super-capacitor 61a for boosting the battery 61 in this embodiment.

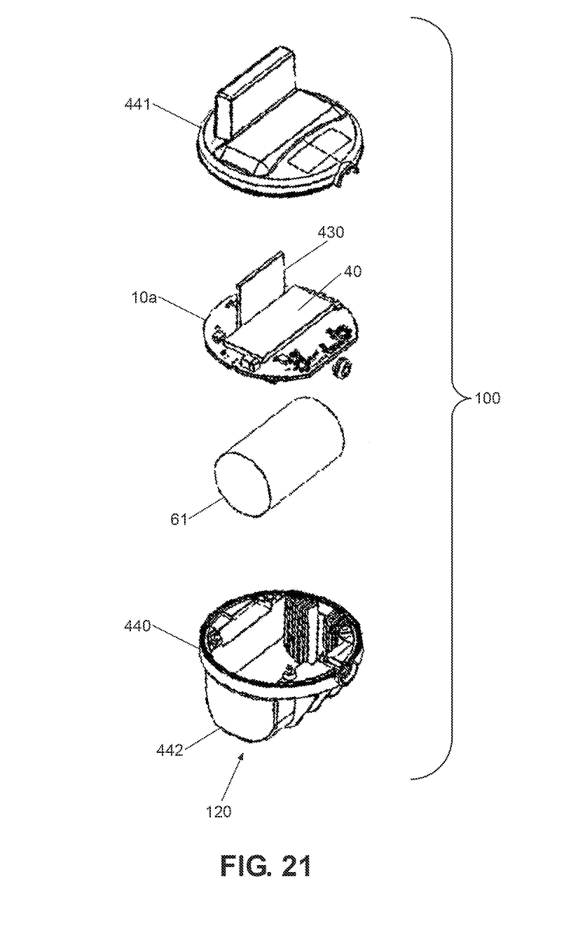

Referring to FIG. 21, this diagram illustrates an exploded view of a multi-function electronic device, serving as a register device 100, adapted to wirelessly communicate with a remote server 300, such as in a wireless utilities metering system 500, in accordance with an embodiment of the present disclosure. The device 100 comprises a primary printed circuit assembly (PCA) and a housing 440 having a top portion 441 and a bottom portion 442, the bottom portion 442 accommodates a power source, such as a battery 443, and a magnetic sensor 445. The top portion 441 accommodates an antenna 430 and a user interface 40, e.g., an LCD. The battery 443 comprises a power cell, such as at least one of a lithium thionyl chloride (Li—SO—C₂) cell, a permanent cell, or a rechargeable cell. The battery 443 comprises a D-size cell, having a capacity in a range of approximately 19 A-hr and a life expectancy of approximately fifteen (15) years. The multi-function electronic device is compliant with standards, such as e-ereg-R FCC 15.247 and IC RSS-210, and comprises a barcode format of 128. The multi-function electronic device comprises a weight of approximately 12 oz.

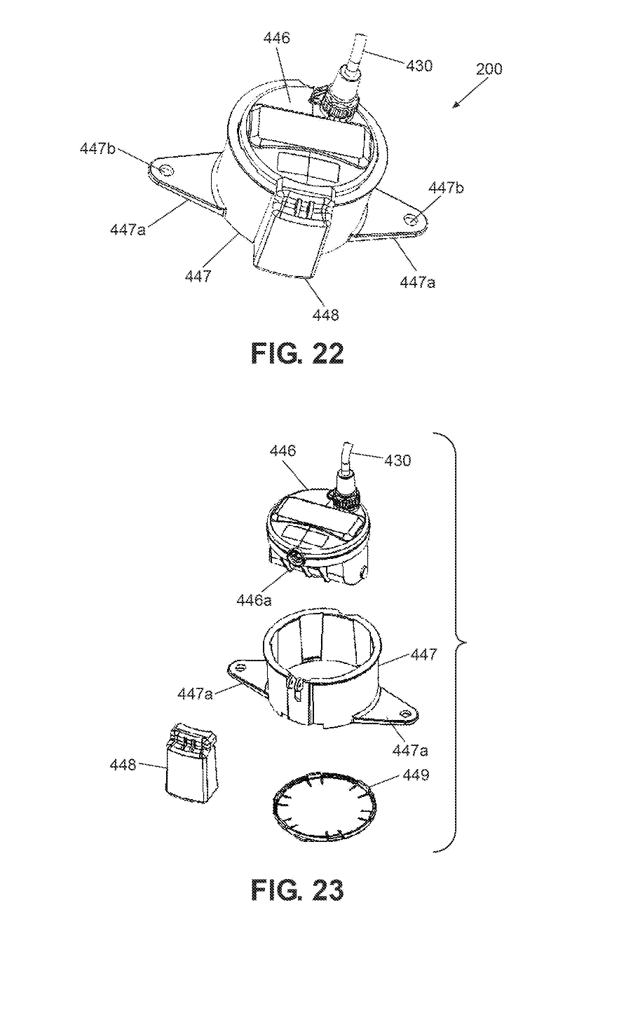

Referring to FIG. 22, this diagram illustrates a top perspective view of a multi-function electronic device, serving as a remote device 200, adapted to wirelessly communicate with a remote server 300, such as in a wireless utilities metering system 500, in accordance with an embodiment of the present disclosure. The device 200 comprises an antenna 430, e.g., a remote antenna, an upper housing portion 446, a remote housing 447, a wiring chamber 448, and a mounting plate 449.

Referring to FIG. 23, this diagram illustrates an exploded view of a multi-function electronic device, serving as a remote device 200, adapted to wirelessly communicate with a remote server 300, such as in a wireless utilities metering system 500, in accordance with an embodiment of the present disclosure. The remote housing 447 comprises at least one flange 447a for facilitating disposition of the device 200 in relation to the fluid metering body 140. The flange 447a has at least one orifice 447b for accommodating at least one fastener (not shown) for mechanically coupling the device 200 with the fluid metering body 140. The upper housing portion 446 comprises an orifice or cable exit 446a for facilitating wiring (not shown) from the cable (not shown) to the PCA 10a.

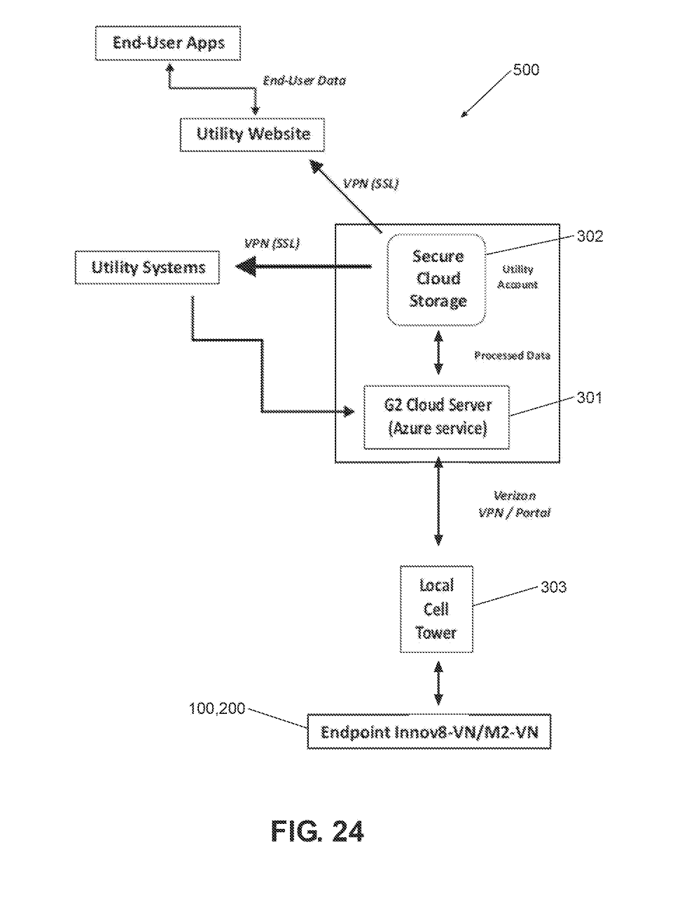

Referring to FIG. 24, this flow diagram illustrates a wireless system 500 for facilitating utility metering, in accordance with the present disclosure. The system 500 performs simple, yet powerful, data collection. For instance, the system 500 provides at least the following benefits: flexible, universal endpoints, e.g., devices 100, 200 the elimination of costly and cumbersome infrastructure, a scale-able AMI network that is compatible with an established wireless carrier, high-resolution interval data, flexible choices of meter data management system (MDMS) and Storage, and a growing suite of end-user data software. Further, the system 500 is readily deployable, infinitely scale-able, and package-able within a single capital expenditure for reliable operations of at least approximately ten years.

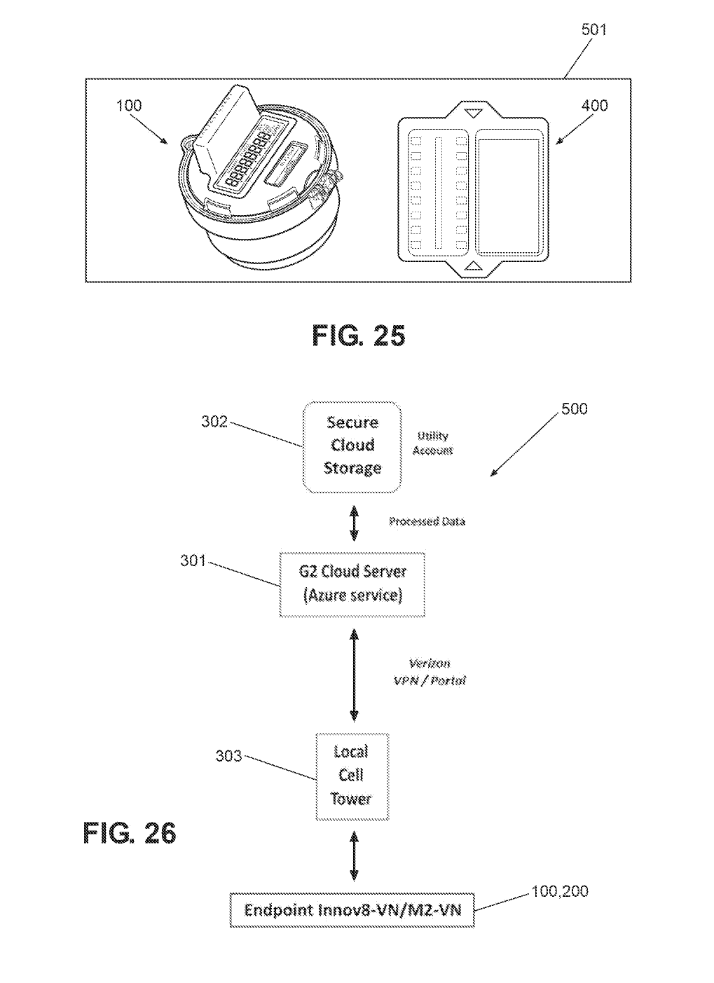

Referring to FIG. 25, these frontal perspective views illustrate a system 500, comprising two different endpoints, the two endpoints comprising an electronic register, such as the register device 100, and a stand-alone modem 400, in accordance with an embodiment of the present disclosure. For example, the electronic register comprises a fully electronic water meter register having a built-in modem, such as a Verizon® network-accessible modem. The electronic register utilizes a unique magnetic sensing of the meter's magnet to track flow with virtually no drag. This sensing technique results in improved accuracy on even “used” or “second-hand” meters. The electronic register measures and stores consumption data to a resolution of each meter magnet turn, thereby facilitating data transmission in intervals of approximately 1 minute. The electronic register utilizes advanced algorithms to identify and flag specific consumption patterns, such as leaks, high usage, conservation violations, backflow and zero usage, or theft. The electronic register is retrofittable in relation to any water meter, such as Metron Spectrum® and Enduro® meters, Sensus SR-II® and PMM® meters, Badger M-series® displacement meter, Neptune T-10® displacement meters, Elster® displacement, Mueller/Hersey® meters, and other meter types of meters. The electronic register further comprises an integral antenna or a remote antenna suitable for mounting in a pit/vault lid.

Still referring to FIG. 25, the stand-alone modem 400, comprising a stand-alone Verizon® network-accessible modem, by example only, is operable with almost any existing water meter register in the industry. The stand-alone modem 400 utilizes flexible input circuitry for interfacing with almost any encoded, pulsed, or switch-based register. The stand-alone modem 400 has configurable query and data storage intervals that match the register type. Like the electronic register, the stand-alone modem 400 has configurable functions for detecting leaks, high usage, conservation, back-flow, zero usage, or theft. The stand-alone modem 400 is compatible with at least the following water meter register types: Metron Hawkeye® OER, Sensus SR-II® and ICE®, Badger® ADE, RTR and ROM, Neptune® ProRead, Auto and E-Coder, Elster® Scancoder and Switch, Hersey® Translator and Switch, as well as other register types.

Still referring to FIG. 25 and referring to FIG. 26, the endpoints automatically wake once-per-day, such as during local super off-peak hours, and connect to a nearby Verizon Wireless® cell tower. This negotiation establishes a dynamic IP address for the respective endpoints on a secure Verizon® virtual private network (VPN) and allows the endpoint to communicate on the network. By example only, the endpoints can communicate only on the isolated Verizon® VPN; and all data is funneled through the NPhase portal. This portal is a management tool to monitor the endpoints' modems and to track network data usage. As soon as the network connection is established, the virtual network (VN) endpoint transmits its standard packet to a preset IP address. The data packet includes meter and modem information, diagnostic data plus the daily interval data. Following the transmission of the data packet, the endpoint waits for either an acknowledgement or for a command from the system 500.

Referring to FIG. 26, this flow diagram illustrates a wireless system 500 for facilitating utility metering, in accordance with the present disclosure. With respect to data communication, the endpoints, such as the register device 100 and the stand-alone modem 400, store interval data and consumption flags in an on-board memory. This interval data and the consumption flags are maintained long term, e.g., weeks to months, based on the data interval selected, to allow for data integrity and redundancy. The endpoints need to transmit their data to a central storage system way of a local cell tower 303. The AMI network, i.e., the backbone of the system 500, comprises a path from the endpoints to a cloud computing site, such as a cloud server 301. The system 500 may utilize Verizon Wireless® nationwide CDMA network as the Verizon® network supports machine-to-machine (M2M) communications applications.

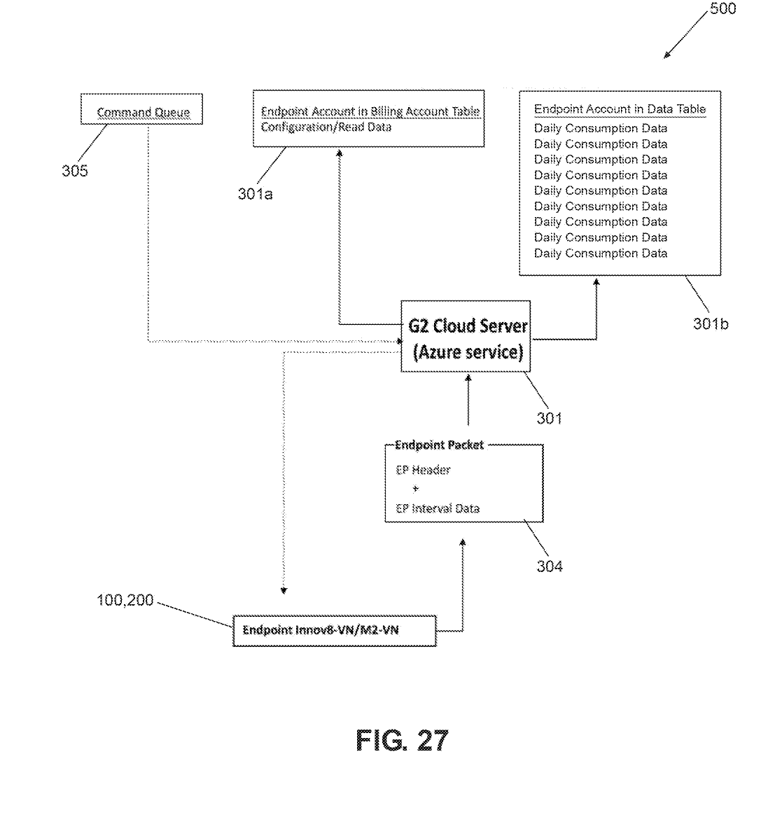

Referring to FIG. 27, this flow diagram illustrates a system 500, comprising two different endpoints, the two endpoints comprising an electronic register, such as the register device 100, and a stand-alone modem 400, in accordance with an embodiment of the present disclosure. The data packets 304 from each utility's endpoints are received by a custom software service, such as a cloud server 301, e.g., a G2 Cloud Server. This software application runs as a service in the Microsoft Azure® cloud fabric and corresponds to the unique preset URL address for each utility. The cloud server 301 processes and validates all data packets 304, updates the account data, and deposits the interval data into the long-term data storage, e.g., secure cloud storage 302. The data packets 304 contain a header comprising an ID, module information, an instantaneous reading, and 1- to 5-minute interval data which provides the resolution for applications or activities, such as demand billing, district metering, leak studies, and more.

Still referring to FIG. 27, the cloud server 301, e.g., G2 Cloud Server, also maintains a command queue 305. The command queue 305 comprises a list of requests and instructions for specific endpoints. Following receipt of data packets 304, the cloud server 301 responds to each endpoint with a positive acknowledgement of the data packet 304 or with a command request for those endpoints with queued items. Commands comprise requests for additional data (to fill data voids), reconfiguration, operational firmware uploads, specific modem instructions, and updates. With respect to data storage, the system 500 utilizes a secure cloud-based storage 302 with a PC-based G2 Central MDM system. Rather than using dedicated servers at the utility site, the system 500, by way of the Verizon network system, utilizes cloud computing for a completely secure, redundant hosted system. The system 500 also utilizes the Microsoft Azure® cloud computing services which run on vast Microsoft® data centers.

Still referring to FIG. 27, the data files are located in the secure cloud-based storage 302, e.g., Microsoft Azure® storage, which is multi-redundant, secure, and highly accessible. Data sets in the Azure® cloud are replicated three times within the same physical data center, plus are geo-replicated in separate areas for extreme hardware fault tolerance. The cloud server 301, e.g., G2 Cloud Server, also uses recommended “best-practices” for identity management, access authentication, and data/key isolation. Independent cloud storage tables are created for each utility. The cloud tables are structured into account tables 301a, 301b and long-term data storage tables. All account data is encrypted.

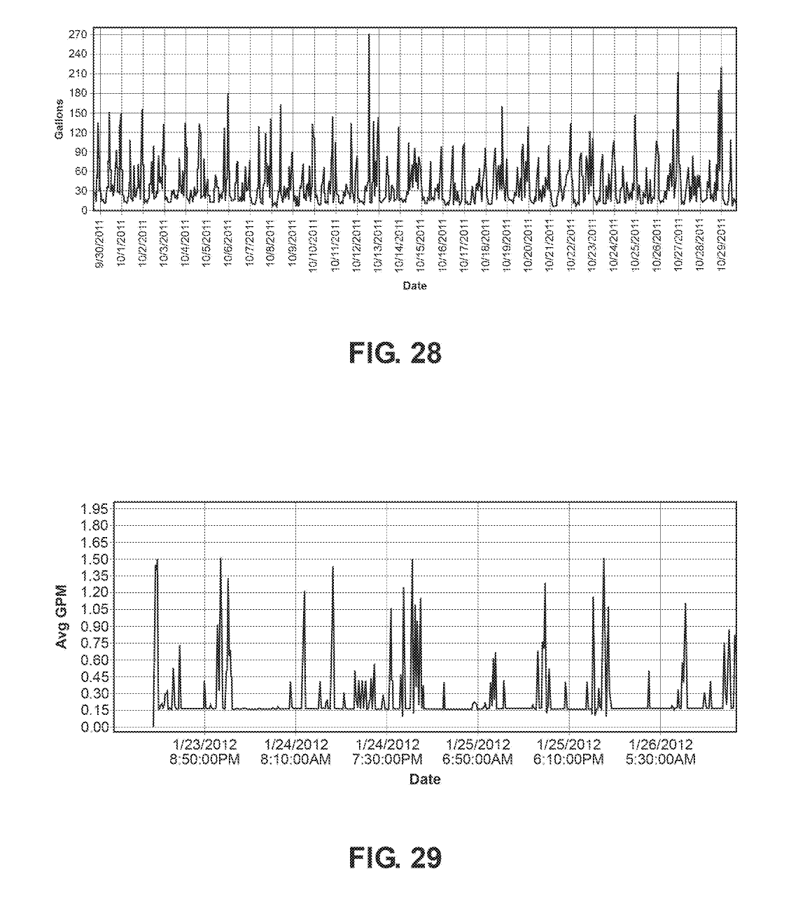

Referring to FIG. 28, this screenshot illustrates an account table T₃ in a window W₁ configured to maintain and present record information on each utility account, generated by a wireless utilities metering system 500, in accordance with an embodiment of the present disclosure. This includes all account information, as downloaded from the utility billing/customer service system, i.e., account number, address, measurement units, and the like. The account table T₃ also includes the account status, the most recent billing read, and any consumption flags. This table T₃ provides quick information access for the G2 Central Utility Software. The long-term data storage 302 is structured within simple Azure cloud tables. The long-term storage is simply appended daily interval data. The purpose of the long-term data storage 302 is for building consumption histories for customer service, engineering, analysis and maintenance purposes. The long-term data is available to the utility software and optionally to end-users. The system 500 uses a software program for populating past billing data archives into the data storage 302 for comparative analysis purposes. This allows the utility company to readily use the software functionality.

Still referring to FIG. 28, the G2 central mobile device management software (MDMS) software is the primary user interface tool for the utility personnel. The G2 central MDMS is a stand-alone package which accesses the account data from either the cloud storage via a secure VPN or a dedicated utility relational database management software (RDBMS). The G2 central MDMS uses a scheduler to automatically populate account data for regular billing files and reports. Beyond standard billing purposes, the software has flexible data analysis and manipulation tools. The G2 central MDMS can access the long-term data storage accounts at any time to produce historical analysis and consumption reports for customer service, maintenance and engineering.

Still referring to FIG. 28, the G2 central MDMS is PC-based and serves the following functions: as a monthly billing data interface, wherein the software is configured to automatically query the account tables for time-coordinated billing files to be uploaded to the billing system, as an individual account review, wherein the software reviews current account status, including account information, current monthly consumption, current consumption flags and notes, as an historical account review, wherein the software reviews historical account consumption data, wherein this data is presented in graphical format in yearly, month, daily or hourly format, and wherein the user is provided with statistics and approximate flow-rate data for high resolution accounts, as a data reporting tool, wherein the software generates a wide range of reports such as high/low consumption, maintenance, probable leaks, high usage, conservation violations, zero-usage, back-flow, and many other conditions, as a system status provider, wherein the software provides system reading performance status and statistics at any time.

Referring to FIG. 29, this screenshot illustrates an account table T₄ in a window W₂ configured to maintain and present record information for the end user, generated by a wireless utilities metering system 500, in accordance with an embodiment of the present disclosure. The system 500 includes a suite of end-user account review applications for popular platforms, including basic browsers. The system 500 is configurable to support for iOS (iPhones/iPads) and Android devices. These iOS (iPhones/iPads) and Android applications access the water utility's homepage to access an account login page. With the correct login information, the end-user is able to conduct at least the following activities: setup email notifications for consumption events (high usage, leaks, etc.), access current account information, and access historical account information. Such information is presented in a graphical format and is easily re-formatted to show yearly, monthly, daily, and even hourly consumption patterns. The end-user software suite is configured to expand with customer requests and suggestions.

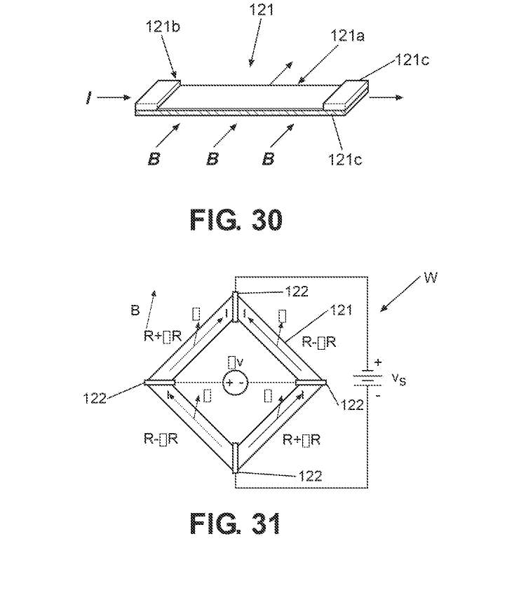

Referring to FIG. 30 and referring back to FIG. 3, the sensor 120 comprises a magnetic field sensor having a magnetic position sensing feature that uses at least one anisotropic magneto-resistive sensor, such as a resistive element 121, in accordance with the present disclosure. Anisotropic magneto-resistive sensors are adapted to identify a disposition, motion, and direction of an object in a noninvasive and non-contacting manner. By affixing a magnet element or a sensor element to an object that is angularly or linearly moving, while maintaining a complementary stationary sensor element or magnet element, the relative direction of a resulting magnetic field B is electronically quantified. By using a plurality of sensors or magnets, the capability of the sensor 120 for making extended angular or linear position measurements is enhanced. This following discussion relates to the principles of anisotropic magneto-resistive sensors for positional measurements.

Referring to FIG. 31, this diagram illustrates the principles of anisotropic magneto-resistive sensor operation as performed by the sensor 120, e.g., utilizing an anisotropic magneto-resistance technique, wherein anisotropic magneto-resistance occurs in certain ferrous materials, and wherein such certain ferrous materials are applied as a thin strip, thereby providing a resistive element, in accordance with an embodiment of the present disclosure. The sensor 120 comprises a Wheatstone bridge W having a plurality of resistive elements 121, e.g., four resistive elements, wherein each resistive element 121 of the plurality of resistive elements 121 comprises at least one ferrous material, such as Permalloy®, by example only. Each resistive element comprises a resistance R and is capable of changing resistance ΔR in a cos²θ relationship, wherein θ is an angle subtended by a magnetic moment vector M_{mag} and a current flow vector I.

Still referring to FIG. 31, Permalloy® comprises a nickel-iron (NiFe) magnetic alloy, e.g., comprising approximately 20% iron and approximately 80% nickel, and having a very high magnetic permeability, e.g., approximately 100,000. In addition to high permeability, Permalloy® comprises other magnetic properties that facilitate operation of the sensor 120, such as low coercivity, near-zero magnetostriction, and significant anisotropic magneto-resistance. Permalloy® further comprises an electrical resistivity capable of varying as much as approximately 5%, depending on the strength and the direction of an applied magnetic field, e.g., an applied magnetic field B. Permalloy® further comprises a face-centered cubic crystal structure with a lattice constant of approximately 0.355 nm in a vicinity of a nickel concentration of 80%. Permalloy® further comprises other compositions that are designated by a numerical prefix denoting a percentage of nickel in the alloy. For example, “45 Permalloy®” denotes an alloy comprising approximately 45% Ni and approximately 55% Fe. In addition, “Molybdenum Permalloy®” is an alloy comprising approximately 81% Ni, approximately 17% Fe, and approximately 2% Mo. “Supermalloy” is an alloy comprising approximately 79% Ni, approximately 16% Fe, and approximately 5% Mo (Bozorth), and provides high performance as a soft magnetic material that is characterized by high permeability as well as low coercivity.

Referring to FIG. 31 and referring back to FIG. 30, during operation, the resistive element 121 experiences a magnetic field B and an applied current I. For example, to fabricate the sensor 120 from the anisotropic magneto-resistive elements, four resistive elements 121 are oriented in a polygon configuration, e.g., a diamond shape, being coupled together, end to end, by a coupling technique, such as metallization, thereby forming the Wheatstone bridge W. In operation, a pair of opposing couplings 122 of the four resistive elements 121, e.g., four identical resistive elements, experiences an applied direct current (DC) stimulus, comprising a supply voltage Vₛ, wherein a remaining pair of opposing couplings 122 is to be measured. Without an applied magnetic field, e.g., 0 gauss, the remaining pair of opposing couplings 122 should be measured as having a same or approximately same voltage, e.g., excepting a small offset voltage due to manufacturing tolerances on the resistive elements 121. With the resistive elements 121 coupled in the Wheatstone bridge W configuration, the remaining pair of opposing couplings 122 produces a differential voltage output ΔV as a function of the supply voltage Vₛ, a magneto-resistance ratio MR, and experiences a magnetization with a magnetic field B and a current flow in a relationship defined by an angle θ₁, wherein θ₁ is the angle subtended by an element magnetization vector M_{mag} and the element current flow vector I.

Still referring to FIG. 31, this diagram illustrates the Wheatstone bridge W, in accordance with an embodiment of the present disclosure. By aligning the element magnetization direction M_{mag} with an externally applied magnetic field B, the externally applied field B must “saturate” the magneto-resistive material. As opposed to other anisotropic magneto-resistive sensor elements that typically operate in a linear mode, the position sensing of the present disclosure performs a saturation mode function. In essence, the externally applied field B reorients, or completely reorients, the magneto-resistive material's magnetization. For the sensor 120, the externally applied field B comprises a magnitude of at least approximately 80 gauss, being applied at the Wheatstone bridge W for optimum performance, in accordance with the present disclosure. While an externally applied field B, comprising a magnitude of less than approximately 80 gauss provides some bridge operation, a condition of complete saturation is preferable as such condition is much more reliable.

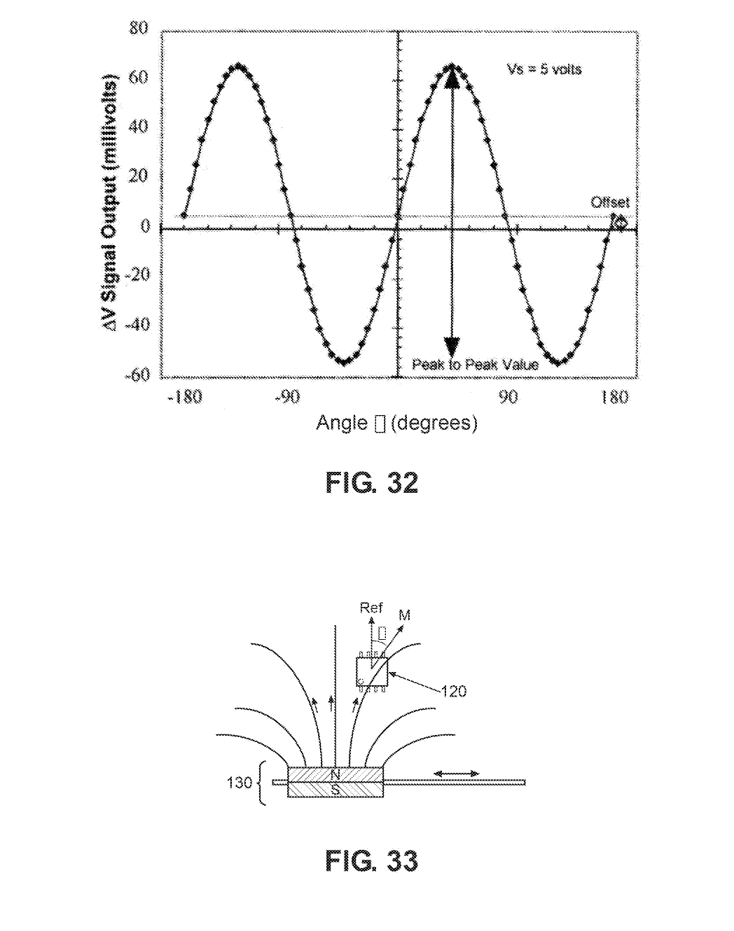

Referring to FIG. 32, this graph illustrates a two-cycle waveform plot of signal output versus angle θ for the pair of Wheatstone bridges W configuration, as shown in FIG. 31, in accordance with the present disclosure. With respect to output signals, the sensor 120 comprises at least one of the following configurations: a single Wheatstone bridge W for an approximately +45°/−45° range of position sensing and a pair of Wheatstone bridges W for an approximately +90°/−90° range of position sensing. The single Wheatstone bridge W configuration produces a differential voltage output ΔV that is expressed as follows: ΔV=−Vₛ S sin(2θ), wherein Vₛ=a supply voltage (volts), S=a material constant (12 mV/V), and θ=a reference angle subtended by a magnetic field vector (degrees) and an applied current vector. In the pair of Wheatstone bridges W configuration, a first Wheatstone bridge W is disposed at an angle of approximately 45° in relation to a second Wheatstone bridge W. The first Wheatstone bridge W produces a differential voltage output ΔV₁ that is expressed as follows: ΔV₁=Vₛ S sin(20). The second Wheatstone bridge W produces a differential voltage output ΔV₂ that is expressed as follows: ΔV₂=−Vₛ S cos(2θ).

Still referring to FIG. 32, the most linear range for the pair of Wheatstone bridges W configuration is in the approximately +45°/−45° range about the −180°, −90°, 0°, +90°, and +180° points. Of these points, the 0°, +180°, and −180° points have a positive slope; and the +90°/−90° points have a negative slope, wherein these slopes are for angular and linear positioning by the sensor 120. Further, the sensor 120 is adapted to adjust for some errors, whereby measurement accuracy is enhanced. An error comprises a voltage offset error due to manufacturing tolerances. To compensate for the voltage offset error, either analog signal processing or digital value corrections are used by the sensor 120. The analog signal processing solution comprises summing an opposing error voltage into the bridge output signal via signal conditioning circuitry. The digital solution comprises combining the digitized value of the output signal with an error correction value. Another common error is a drift in the material constant as a function of temperature, affecting both the bridge sensitivity and offset. The coefficients of temperature for the sensitivity and the offset are respectively approximately −0.32%/° C. and approximately −0.01%/° C.

Referring to FIG. 33, the sensor 120, comprising the single Wheatstone bridge W configuration, e.g., in a stationary position, detects a relative motion of a nearby magnet, e.g., a meter magnet 130, in linear or angular displacement for simple magnetic position sensing, in accordance with an embodiment of the present disclosure. The meter magnet 130 can translate to +45°/−45° and stay within a linear slope of ΔV versus θ for position sensing. By example only, for a supply voltage of approximately 5 volts (Vₛ=+5 VDC), the single Wheatstone bridge W configuration provides a voltage swing of approximately a 120 mV swing (+60 mV/−60 mV) on 2.5-V bias voltage. The 2.5-V bias voltage is used, because with the supply voltages at 0 V and +5 V, the sensor 120, comprising the single Wheatstone bridge W configuration, performs a rail-splitter function, thereby forming two approximately +2.5-V sources that are driven apart by ΔV that is produced by the magnetic field and the offset error voltage.

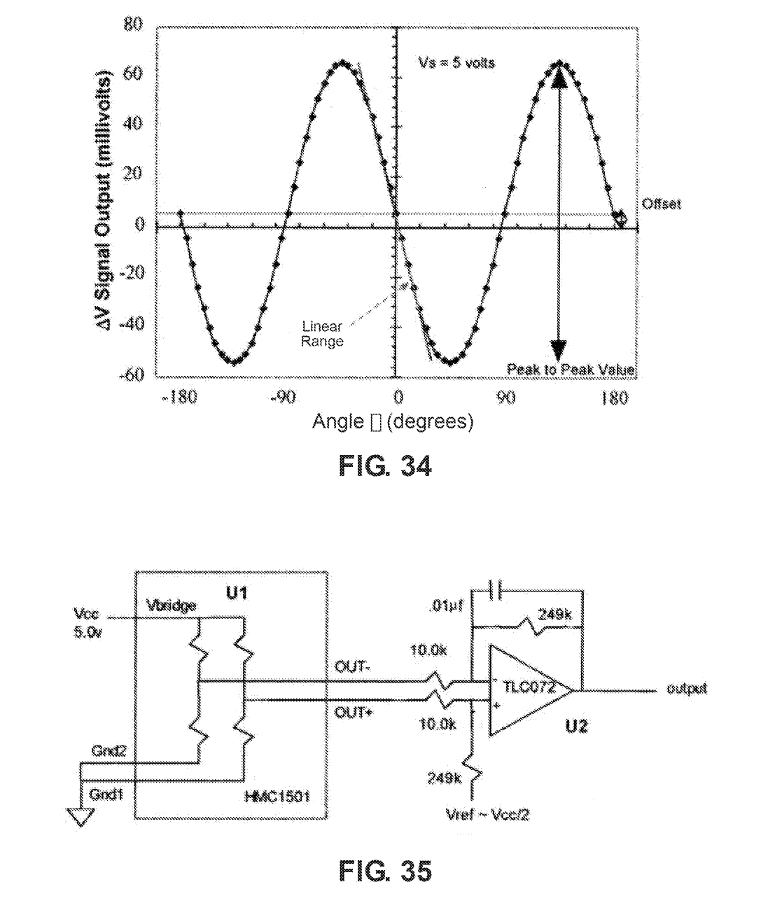

Referring to FIG. 34, this graph illustrates a transfer curve related to the operation of the sensor 120, as shown in FIG. 30. To interface with output pins (OUT+, OUT−) of the sensor 120, comprising the single Wheatstone bridge W configuration, e.g., in a stationary position, the sensor 120 further comprises an instrumentation amplifier circuit, wherein the instrumentation amplifier circuit comprises at least one of a complete integrated circuit and a combination of discrete components and integrated circuits, such as operational amplifiers (op-amps). The instrumentation amplifier circuit derives the difference signal (OUT+minus OUT−) and provides additional signal amplification as desired.

Referring to FIG. 35, this circuit diagram illustrates an instrumentation amplifier circuit, using an op-amp with external discrete components, as incorporated in the sensor 120, I accordance with an embodiment of the present disclosure. With a nominal 120 mV peak-to-peak signal swing at the bridge outputs, FIG. 32 shows an instrumentation amplifier with a voltage gain of about 25, thereby facilitating an output voltage swing of approximately 3 V peak-to-peak and centered at approximately 2.5 V, e.g., in a range of approximately 1 V to approximately 4 V. Since the bridge offset specification is approximately +7 mV/−7 mV per volt, a 5-volt supply voltage is applied to the bridge, thereby yielding approximately +35 mV/−35 mV. This offset is approximately +850 mV/−850 mV after the instrumentation amplifier gain, which will stay within the power supply rails when combined with the amplified signal. One method of countering the offset error voltage at the bridge is to change the value of V_{ref} at the instrumentation amplifier from 2.5 V to a nearby voltage, wherein the amplifier output voltage remains at 2.5 V at each 90° rotation in the field direction.

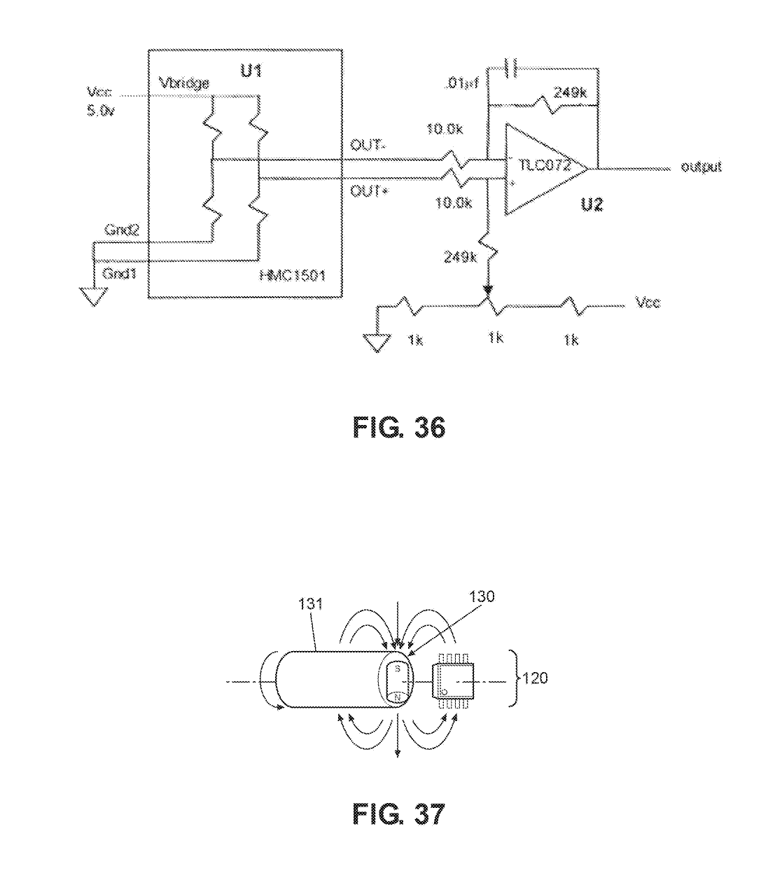

Referring to FIG. 36, Countering the offset error voltage, as described in relation to FIG. 32, comprises using a trimming potentiometer (trimmer pot) with the wiper to V_{ref} and the end positions of the potentiometer towards each supply rail, in accordance with an embodiment of the present disclosure. Offset error voltage compensation also comprises measuring the voltage during a production test and subtracting that value from all future measurements, wherein the circuit component count remains minimal, as shown in FIG. 32, and wherein no trimming procedure is required. However, the amplifier gain may require a reduction for accommodating the error buildup in offset and sensitivity tolerances as well as temperature coefficient changes that are all multiplied by the amplifier gain.

Referring to FIG. 37, this diagram illustrates the sensor 120, comprising either two single Wheatstone bridges W or a pair of Wheatstone bridges W, for facilitating measurement of a rotation in a range of approximately +45°/−45° to approximately +90°/−90, in accordance with an embodiment of the present disclosure. By using either two single Wheatstone bridges W or a pair of Wheatstone bridges W with a 45° displacement from each other, the two linear slopes can be used additively. As a shaft 131 rotates, a magnetic flux from a magnet 130 disposed at a distal end of the shaft 131 exits the North Pole N of the magnet 130 and returns to the south pole S of the magnet 130. With either two single Wheatstone bridges W or a pair of Wheatstone bridges W disposed along a major axis of the shaft 131 and spaced apart from the magnet 130, the flux passing through the sensor 120 will retain the orientation of the magnet 130.

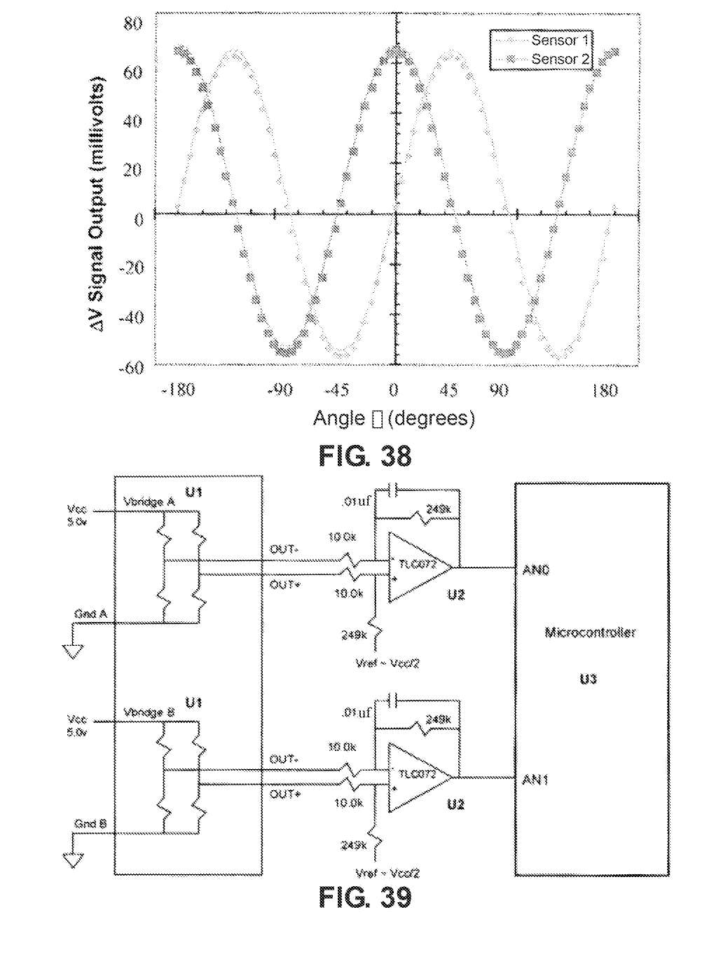

Referring to FIG. 38, this graph illustrates sine and cosine waveforms produced by output of the sensor 120, comprising either two single Wheatstone bridges W or a pair of Wheatstone bridges W, as shown in FIG. 34, in accordance with an embodiment of the present disclosure. Because the sine (from the first sensor Wheatstone bridges W) and cosine (from the second sensor Wheatstone bridges W) matches after the offset error voltages are subtracted, the ratio of sine (from the first sensor Wheatstone bridges W) and cosine (from the second sensor Wheatstone bridges W) results in a tangent 2θ function and the amplitude A values cancel. As such, the angle θ is expressed as: θ=0.5*arctan(ΔV₁/ΔV₂). However, since some trigonometric nuances occur in the arctangent function when θ approaches +45°/−45° and beyond, the following special cases apply: for ΔV₁=0, θ=0°; for ΔV₂=0 and ΔV₁=/<0, θ=−45°; for ΔV₂=0 and ΔV₁=/>0, θ=+45°; for ΔV₁<0 and ΔV₂<0, 90° is subtracted from θ; for ΔV₁>0 and ΔV₂<0, 90° is added to θ.

Referring to FIG. 39, this circuit diagram illustrates a general circuit for a pair of Wheatstone bridges W, as shown in FIG. 37, in accordance with an embodiment of the present disclosure. Because most trigonometric functions are performed as memory maps in microcontroller integrated circuits, these special case conditions are readily handled by at least one of the sensor 120 and the microcontroller 10. The resultant angle θ comprises the relative position of the magnetic field B with respect to the sensor 120. If rotation is permitted beyond +90°/−90°, the θ calculation repeats with positive and negative 90° readings jumping at the end points. Further performance to 360° or +180°/−180° is mapped into the microcontroller 10 by using this circuit in combination with a Hall Effect sensor to determine which side of the shaft is being positionally measured via magnetic polarity detection.

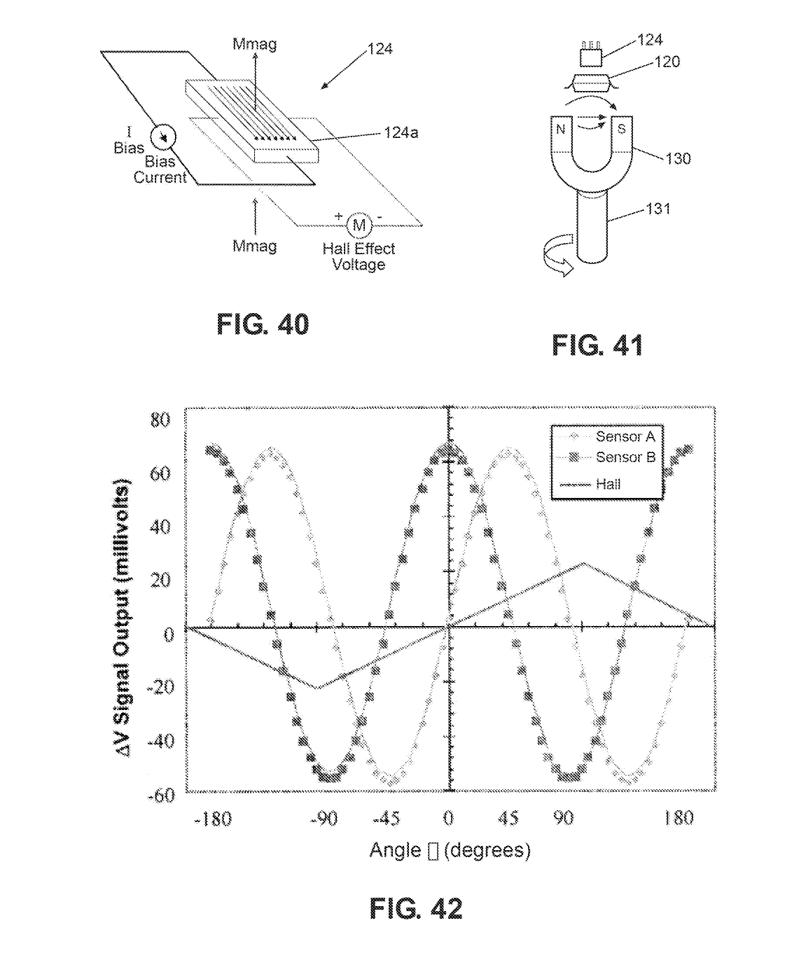

Referring to FIG. 40, this diagram illustrates a Hall-Effect sensor 124 for use with a pair of Wheatstone bridges W, as shown in FIG. 37, for providing full 360° rotational position sensing, in accordance with an embodiment of the present disclosure. Most Hall-Effect sensors 124 comprise a silicon semiconducting material 124a for imparting a proportional voltage output as a magnetic field vector M_{mag} slices orthogonally through the semiconducting material 124a with a bias current I_{bias} flowing through the semiconducting material 124a.

Referring to FIG. 41, this diagram illustrates the sensor 120 used in combination with a Hall-Effect sensors 124 for sensing a 360° rotation of a magnet 130, in accordance with an embodiment of the present disclosure. Although Hall-Effect sensors 124 may not provide the sensitivity or precision for accurate position sensing, they are used for 360° position sensing as “polarity” detectors to determine in which half of the sensor 120 that a rotation of a magnet is detected.

Referring to FIG. 42, this graph illustrates resulting waveforms for 360° position sensing. As shown in FIG. 53, in accordance with an embodiment of the present disclosure. As the magnetic flux rotates about the sensor 120 and the Hall-Effect sensor 124, the Hall-Effect sensor's 124 voltage reverses polarity as the flux vector changes from back-to-front to front-to-back through the semiconducting material 124a. By placing a comparator on an analog output of the Hall-Effect sensor 124, a digital representation of half-rotation polarity is achieved. When combined with +90°/−90° sensing circuits of the sensor 120, the sensing range is approximately doubled, thereby providing a complete +180°/−180° or 360° rotational sensor of high accuracy. Preferably, the Hall-Effect sensor 124 is nearly perfectly orientated with respect to the sensor 120, so that the arctangent equation, deriving the heading, arrives at the end positions just as the Hall-Effect sensor 124 output achieves a zero-volt output.

Information as herein shown and described in detail is fully capable of attaining the above-described object of the present disclosure, the presently preferred embodiment of the present disclosure, and is, thus, representative of the subject matter which is broadly contemplated by the present disclosure. The scope of the present disclosure fully encompasses other embodiments which may become obvious to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, as may be apparent to those of ordinary skill in the art, are also encompassed by the present disclosure.

What is claimed:

1. An electronic device, comprising:
a processor;
a power source in electronic communication with the processor; and
means for wirelessly communicating, the wirelessly communicating means in electronic communication with the processor and the power source,
the processor controlling the wirelessly communicating means in a manner that minimizes power consumption by the electronic device, whereby the power source is conserved, and
the electronic device being adapted to serve at least one function, wherein the at least one function comprises a register device and a remote device.

2. The device of claim 1, wherein the wirelessly communicating means comprises a cellular feature for communicating utility usage data to at least one of a server, a remote server, a cloud-based server, a remote cloud-based server

3. The device of claim 1, wherein the wirelessly communicating means is adapted to transmit data only in binary packets for minimizing usage of bandwidth.

4. The device of claim 1, wherein the wirelessly communicating means is adapted to transmit data only during off-peak hours for minimizing power consumption.

5. The device of claim 1,
wherein the wirelessly communicating means is adapted to receive data, and
wherein the wirelessly communicating means is adapted to effect a fluid shut-off.

6. The device of claim 1, further comprising an onboard real-time clock in electronic communication with the processor.

7. The device of claim 1, further comprising at least one metering body interface feature for facilitating universal disposition of the electronic device in relation to any metering body.

8. The device of claim 1, further comprising at least one magnetic-field sensor in electronic communication with the processor.

9. The device of claim 8, wherein the at least one magnetic-field sensor is adapted to perform at least one sensor function of:
performing an accurate reading of at least one parameter of a utility usage, a fluid usage, and a water usage;
performing a high resolution detection of water usage by performing frequent accurate readings, whereby performance of a metering body is enhanced; and
detecting at least one indication of a high flow, low flow, consistent flow, inconsistent flow, non-flow, back-flow, tampering of the metering body, and removal of the metering body.

10. The device of claim 9, wherein the processor executes a software program, using data provided by the at least one magnetic-field sensor, for identifying at least one utility usage pattern.

11. A wireless system, comprising:
at least one electronic device in communication with at least one server, the at least one electronic device, comprising:
a processor;
a power source in electronic communication with the processor; and
means for wirelessly communicating, the wirelessly communicating means in electronic communication with the processor and the power source,
the processor controlling the wirelessly communicating means in a manner that minimizes power consumption by the electronic device, whereby the power source is conserved, and
the electronic device being adapted to serve at least one function, wherein the at least one function comprises a register device and a remote device.

12. The system of claim 11, wherein the wirelessly communicating means comprises a cellular feature for communicating utility usage data to the at least one server.

13. A method of handling utility usage data, comprising:
collecting utility usage data by at least one magnetic-field sensor; and
transmitting the utility usage data to at least one server by a wireless communicator;
wherein the transmitting step is performed only in binary packets for minimizing usage of bandwidth, and
wherein the transmitting step is performed only during off-peak hours for minimizing power consumption.

14. The method of claim 13, wherein the transmitting step is performed by the wireless communicator, comprising a cellular feature, for communicating utility usage data to the at least one server

15. An electronic device, comprising:
a processor;
a power source in electronic communication with the processor; and
at least one magnetic-field sensor in electronic communication with the processor,
the electronic device being adapted to serve at least one function, wherein the at least one function comprises a register device and a remote device.

16. The device of claim 15, further comprising means for wirelessly communicating, the wirelessly communicating means in electronic communication with the processor and the power source, the processor controlling the wirelessly communicating means in a manner that minimizes power consumption by the electronic device, whereby the power source is conserved.

17. The device of claim 15, wherein the wirelessly communicating means comprises a cellular feature for communicating utility usage data to at least one of a server, a remote server, a cloud-based server, a remote cloud-based server.

18. The device of claim 15, wherein the wirelessly communicating means is adapted to transmit data only in binary packets for minimizing usage of bandwidth.

19. The device of claim 15, wherein the wirelessly communicating means is adapted to transmit data only during off-peak hours for minimizing power consumption.

20. The device of claim 15, wherein the wirelessly communicating means is adapted to receive data, and wherein the wirelessly communicating means is adapted to effect a fluid shut-off.

21. The device of claim 15, wherein the at least one magnetic-field sensor is adapted to perform at least one sensor function of:
performing an accurate reading of at least one parameter of a utility usage, a fluid usage, and a water usage;
performing a high resolution detection of water usage by performing frequent accurate readings, whereby performance of a metering body is enhanced; and
detecting at least one indication of a high flow, low flow, consistent flow, inconsistent flow, non-flow, back-flow, tampering of the metering body, and removal of the metering body.

22. The device of claim 15, wherein the processor executes a software program, using data provided by the at least one magnetic-field sensor, for identifying at least one utility usage pattern.
